(19) United States
(12) Patent Application Publication
(10) Pub. No.: US 2006/0276337 A1
(43) Pub. Date: Dec. 7, 2006

(54) Oil suspension concentrate

(75) Inventors: Frank Sixl, Rechtsupweg (DE); Annika Schmidt, Runkel (DE)

Correspondence Address: STERNE, KESSLER, GOLDSTEIN & FOX PLLC, 1100 NEW YORK AVENUE, N.W., WASHINGTON, DC, 20005, US

(73) Assignee: BAYER CROPSCIENCE GMBH, Frankfurt (DE)

(21) Appl. No.: 11/445,444

(22) Filed: Jun. 2, 2006

(30) Foreign Application Priority Data
Jun. 4, 2005 (EP) 05012120.1

(51) Int. Cl. A01N 47/36; A01N 25/32; A01N 25/04

(52) U.S. Cl. 504/104; 504/211; 504/364

(57) ABSTRACT

The present invention relates to an oil suspension concentrate comprising a) one or more herbicidally active compounds from the group of the pyridylsulfonylureas in suspended form, and b) one or more organic solvents. The oil suspension concentrate is suitable for use in crop protection.

The present invention relates to the field of the formulations of crop protection agents. In particular, the invention relates to liquid formulations in the form of oil suspension concentrates comprising herbicidally active compounds from the group of the pyridylsulfonylureas.

Active compounds for crop protection are generally not employed in their pure form. Depending on the area of use and the type of use, and also on physical, chemical and biological parameters, the active compound is employed in a mixture with customary auxiliaries and additives as an active compound formulation. Also known are combinations with further active compounds for broadening the activity spectrum and/or for protecting the crop plants (for example with safeners, antidotes).

In general, formulations of active compounds for crop protection should have high chemical and physical stability, should be easy to apply and user friendly and have a broad biological action with high selectivity.

Herbicidally active compounds from the group of the sulfonylureas generally have high chemical reactivity and tend to suffer from chemical degradation, for example by hydrolysis.

One option of formulating chemically unstable active compounds is the preparation of solid formulations. Thus, formulations of active compounds from the group of the sulfonylureas in the form of powders, granules and tablets are known (for example in EP 764404, WO 9834482, WO 9313658). However, the processes for preparing solid formulations, for example in the form of granules and tablets, are generally complicated, in particular when auxiliaries and additives or active compounds having a low melting point are incorporated. Moreover, solid formulations are generally more difficult to apply and less user friendly.

Liquid formulations of sulfonylureas are described, for example, in U.S. Pat. No. 4,599,412, U.S. Pat. No. 4,683,000, U.S. Pat. No. 4,671,817, EP 0245058, WO 01/82693, EP 0313317, EP 0514768, EP 0163598 and EP 0514769. Pyridylsulfonylureas are described, for example, in U.S. Pat. No. 5,476,936.

It was an object of the present invention to provide an improved formulation of crop protection agents having a high chemical and physical stability.

This object is achieved by the specific oil suspension concentrate of the present invention.

Accordingly, the present invention relates to an oil suspension concentrate comprising
a) one or more herbicidally active compounds from the group of the pyridylsulfonylureas in suspended form, and
b) one or more organic solvents.

In addition, the oil suspension concentrate according to the invention may optionally comprise, as further components:
c) one or more safeners,
d) one or more sulfosuccinates,
e) one or more agrochemically active compounds different from a) and c),
f) one or more inorganic salts, and
g) customary auxiliaries and additives.

The term oil suspension concentrate (OD) is to be understood as meaning a suspension concentrate based on organic solvents. Here, one or more active compounds are suspended in the organic solvent; further active compounds may be dissolved in the organic solvent.

In the oil suspension concentrate according to the invention, the pyridylsulfonylurea a) is present in suspended form in the organic solvent. This means that the main proportion (in % by weight) of pyridylsulfonylurea a) is present undissolved in finely distributed form and a minor part of the pyridylsulfonylurea a) may be present in dissolved form. Preferably, more than 50% by weight, particularly preferably more than 80% by weight, of the pyridylsulfonylurea a) is suspended in the organic solvent, in each case based on the total amount of pyridylsulfonylurea a) in the oil suspension concentrate according to the invention.

Preferred pyridylsulfonylureas a) are dioxazinepyridylsulfonylureas, in particular those of the formula (I) 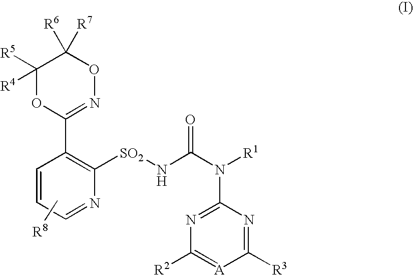
in which
A is nitrogen or a CR¹¹ grouping,
   where
   R¹¹ is hydrogen, alkyl, halogen or haloalkyl,
R¹ is hydrogen or an optionally substituted radical from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴—R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,

where in the radicals mentioned above the alkyl and alkylene groups may each contain 1 to 6 carbon atoms, the alkenyl and alkynyl groups may each contain 2 to 6 carbon atoms, the cycloalkyl groups may each contain 3 to 6 carbon atoms and the aryl groups may each contain 6 or 10 carbon atoms.

The compounds of the formula (I) and their salts are known, as is their preparation, for example from U.S. Pat. No. 5,476,936, the contents of which is incorporated into the present description by way of reference.

Preference is given to compounds of the formula (I) and salts thereof

in which
A is nitrogen or a CH grouping,
R¹ is hydrogen or an optionally halogen-substituted radical from the group consisting of alkyl, alkoxy, alkoxyalkyl, alkenyl and alkynyl having in each case up to 3 carbon atoms,
R² is hydrogen, halogen or is in each case optionally halogen-substituted alkyl, alkoxy, alkylthio, alkylamino or dialkylamino having in each case 1 to 3 carbon atoms in the alkyl radicals,
R³ is hydrogen, halogen or is in each case optionally halogen-substituted alkyl, alkoxy, alkylthio, alkylamino or dialkylamino having in each case 1 to 3 carbon atoms in the alkyl radicals,
R⁴—R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals.

Preference is furthermore given to salts obtained by customary processes from compounds of the formula (I) and bases, such as, for example, sodium hydroxide, potassium hydroxide or calcium hydroxide, sodium hydride, potassium hydride or calcium hydride, sodium amide, potassium amide or calcium amide and sodium carbonate, potassium carbonate or calcium carbonate, sodium C₁-C₄-alkoxides or potassium C₁-C₄-alkoxides, ammonia, C₁-C₄-alkylamines, di-(C₁-C₄-alkyl)amines or tri-(C₁-C₄-alkyl)amines.

Especially preferred are compounds of the formula (I) and salts thereof,

in which
A is nitrogen or a CH grouping,
R¹ is hydrogen, methyl, ethyl, methoxy, methoxymethyl or ethoxy,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴—R⁷ independently of one another are hydrogen, fluorine, chlorine, cyano, or are in each case optionally chlorine- or fluorine-substituted methyl, methylthio, methylsulfinyl, methylsulfonyl, methoxycarbonyl or ethoxycarbonyl, preferably hydrogen,
R⁸ is hydrogen, fluorine, chlorine, bromine, cyano or is in each case optionally chlorine- or fluorine-substituted methyl, methoxy, ethoxy, methylthio, ethylthio, methylsulfinyl, ethylsulfinyl, methylsulfonyl, ethylsulfonyl, methyl- or dimethylamino, preferably hydrogen.

Particular preference is given to compounds of the formula (I) and salts thereof, in particular their alkali metal salts,

in which
A is nitrogen,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴—R⁷ are hydrogen,
R⁸ is hydrogen.

Particular preference is also given to compounds of the formula (I) and salts thereof, in particular their alkali metal salts,

in which
A is a CH grouping,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴—R⁷ are hydrogen,
R⁸ is hydrogen.

The general or preferred radical definitions given above can be combined with one another as desired, i.e. including combinations between the given preferred ranges.

The hydrocarbon radicals mentioned in the radical definitions, such as alkyl, alkenyl or alkynyl, can be straight-chain or branched even if this is not explicitly stated, including in combination with heteroatoms, such as in alkoxy, alkylthio, haloalkyl or alkylamino.

The pyridylsulfonylureas a), for example those of the formula (I), can also be present as salts, for example as metal salts, such as alkali metal (for example Na, K) salts or as alkaline earth metal (for example Ca, Mg) salts or as ammonium salts or amine salts. Such salts are obtained in a simple manner by customary methods for forming salts, for example by dissolving or dispersing a pyridylsulfonylurea, for example of the formula (I), in a suitable diluent, such as, for example, methylene chloride, acetone, tert-butyl methyl ether or toluene, and adding a suitable base. The salts can then—if appropriate after prolonged stirring—be isolated by concentration or filtration with suction.

Herbicidally active compounds a) preferably contained according to the invention are listed in table 1 below, where the following abbreviations are used:
m.p.:=melting point

(+)=the indicated melting point (m.p.) refers to the respective sodium salt, i.e. the corresponding compound in which the hydrogen of the —SO₂—NH— group is replaced by sodium.

TABLE 1
Examples of compounds of the formula (I) where
R⁴ = R⁵ = R⁶ = R⁷ = R⁸ = H:

| | | | | | m.p. |
|---|---|---|---|---|---|
| Ex. No. | R¹ | A | R² | R³ | (° C.) |
| I-1 | H | CH | OCH₃ | OC₂H₅ | 154 |
| I-2 | H | CH | OCH₃ | CH₃ | |
| I-3 | H | CH | OHC₃ | CH₃ | 180-181⁽⁺⁾ |
| I-4 | H | CH | OCH₃ | C₂H₅ | |
| I-5 | H | CH | OCH₃ | CF₃ | |
| I-6 | H | CH | OCH₃ | OCF₂H | |
| I-7 | H | CH | OCH₃ | NHCH₃ | |
| I-8 | H | CH | OCH₃ | N(CH₃)₂ | 199.5 |
| I-9 | H | CH | OCH₃ | Cl | 110-111 |
| I-10 | H | CH | OCH₃ | Cl | 175-178⁽⁺⁾ |
| I-11 | H | CH | OCH₃ | OCH₃ | 167-168 |
| I-12 | H | CH | OCH₃ | OCH₃ | 171-172⁽⁺⁾ |
| I-13 | H | CH | OC₂H₅ | OC₂H₅ | |
| I-14 | H | CH | OC₂H₅ | OC₂H₅ | 152-154⁽⁺⁾ |
| I-15 | H | CH | OC₂H₅ | CH₃ | |
| I-16 | H | CH | OC₂H₅ | C₂H₅ | |
| I-17 | H | CH | OC₂H₅ | CF₃ | |
| I-18 | H | CH | OC₂H₅ | OCF₂H | |
| I-19 | H | CH | OC₂H₅ | NHCH₃ | |
| I-20 | H | CH | OC₂H₅ | N(CH₃)₂ | |
| I-21 | H | CH | OC₂H₅ | Cl | 158-159 |
| I-22 | H | CH | OC₂H₅ | Cl | 213⁽⁺⁾ |
| I-23 | H | CH | CH₃ | CH₃ | 153 |
| I-24 | H | CH | CH₃ | C₂H₅ | |
| I-25 | H | CH | CH₃ | CF₃ | |
| I-26 | H | CH | CH₃ | OCF₂H | |
| I-27 | H | CH | CH₃ | NHCH₃ | |
| I-28 | H | CH | CH₃ | N(CH₃)₂ | |
| I-29 | H | CH | CH₃ | Cl | 108-109 |
| I-30 | H | CH | CH₃ | Cl | >300⁽⁺⁾ |
| I-31 | H | CH | C₂H₅ | C₂H₅ | |
| I-32 | H | CH | C₂H₅ | CF₃ | |
| I-33 | H | CH | C₂H₅ | OCF₂H | |
| I-34 | H | CH | C₂H₅ | NHCH₃ | |
| I-35 | H | CH | C₂H₅ | Cl | |
| I-36 | H | CH | CF₃ | CF₃ | |
| I-37 | H | CH | CF₃ | OCF₂H | |
| I-38 | H | CH | CF₃ | NHCH₃ | |
| I-39 | H | CH | CF₃ | N(CH₃)₂ | |
| I-40 | H | CH | CF₃ | Cl | |
| I-41 | H | CH | OCF₂H | OCF₂H | |
| I-42 | H | CH | OCF₂H | NHCH₃ | |
| I-43 | H | CH | OCF₂H | N(CH₃)₂ | |
| I-44 | H | CH | OCF₂H | Cl | |
| I-45 | H | CH | NHCH₃ | NHCH₃ | |
| I-46 | H | CH | NHCH₃ | N(CH₃)₂ | |
| I-47 | H | CH | NHCH₃ | Cl | |
| I-48 | H | CH | N(CH₃)₂ | N(CH₃)₂ | |
| I-49 | H | CH | N(CH₃)₂ | Cl | |
| I-50 | H | CH | Cl | Cl | |
| I-51 | H | N | OCH₃ | OCH₃ | 255 |
| I-52 | H | N | OCH₃ | OCH₃ | 159-162⁽⁺⁾ |
| I-53 | H | N | OCH₃ | OC₂H₅ | |
| I-54 | H | N | OCH₃ | CH₃ | |
| I-55 | H | N | OCH₃ | C₂H₅ | |
| I-56 | H | N | OCH₃ | CF₃ | |
| I-57 | H | N | OCH₃ | OCF₂H | |
| I-58 | H | N | OCH₃ | NHCH₃ | |
| I-59 | H | N | OCH₃ | N(CH₃)₂ | |
| I-60 | H | N | OCH₃ | N(CH₃)₂ | 156⁽⁺⁾ |
| I-61 | H | N | OCH₃ | Cl | |
| I-62 | H | N | OC₂H₅ | OC₂H₅ | |
| I-63 | H | N | OC₂H₅ | CH₃ | |
| I-64 | H | N | OC₂H₅ | C₂H₅ | |
| I-65 | H | N | OC₂H₅ | CF₃ | |
| I-66 | H | N | OC₂H₅ | OCF₂H | |
| I-67 | H | N | OC₂H₅ | NHCH₃ | |
| I-68 | H | N | OC₂H₅ | N(CH₃)₂ | |
| I-69 | H | N | OC₂H₅ | Cl | |
| I-70 | H | N | OC₂H₅ | Cl | 213⁽⁺⁾ |
| I-71 | H | N | CH₃ | CH₃ | |
| I-72 | H | N | CH₃ | C₂H₅ | |
| I-73 | H | N | CH₃ | CF₃ | |
| I-74 | H | N | CH₃ | OCF₂H | |
| I-75 | H | N | CH₃ | NHCH₃ | |
| I-76 | H | N | CH₃ | N(CH₃)₂ | |
| I-77 | H | N | CH₃ | Cl | |
| I-78 | H | N | C₂H₅ | C₂H₅ | |
| I-79 | H | N | C₂H₅ | CF₃ | |
| I-80 | H | N | C₂H₅ | OCF₂H | |
| I-81 | H | N | C₂H₅ | NHCH₃ | |
| I-82 | H | N | C₂H₅ | Cl | |
| I-83 | H | N | CF₃ | CF₃ | |
| I-84 | H | N | CF₃ | OCF₂H | |
| I-85 | H | N | CF₃ | NHCH₃ | |
| I-86 | H | N | CF₃ | N(CH₃)₂ | |
| I-87 | H | N | CF₃ | Cl | |
| I-88 | H | N | OCF₂H | OCF₂H | |
| I-89 | H | N | OCF₂H | NHCH₃ | |
| I-90 | H | N | OCF₂H | N(CH₃)₂ | |
| I-91 | H | N | OCF₂H | Cl | |
| I-92 | H | N | NHCH₃ | NHCH₃ | |
| I-93 | H | N | NHCH₃ | N(CH₃)₂ | |
| I-94 | H | N | NHCH₃ | Cl | |
| I-95 | H | N | N(CH₃)₂ | N(CH₃)₂ | |
| I-96 | H | N | N(CH₃)₂ | Cl | |
| I-97 | H | N | Cl | Cl | |
| I-98 | CH₃ | N | OCH₃ | OCH₃ | |
| I-99 | CH₃ | N | OCH₃ | OC₂H₅ | |
| I-100 | CH₃ | N | OCH₃ | CH₃ | |
| I-101 | CH₃ | N | OCH₃ | C₂H₅ | |
| I-102 | CH₃ | N | OCH₃ | CF₃ | |
| I-103 | CH₃ | N | OCH₃ | OCF₂H | |
| I-104 | CH₃ | N | OCH₃ | NHCH₃ | |
| I-105 | CH₃ | N | OCH₃ | N(CH₃)₂ | |
| I-106 | CH₃ | N | OCH₃ | Cl | |
| I-107 | CH₃ | N | OC₂H₅ | OC₂H₅ | |
| I-108 | CH₃ | N | OC₂H₅ | CH₃ | |
| I-109 | CH₃ | N | OC₂H₅ | C₂H₅ | |
| I-110 | CH₃ | N | OC₂H₅ | CF₃ | |
| I-111 | CH₃ | N | OC₂H₅ | OCF₂H | |
| I-112 | CH₃ | N | OC₂H₅ | NHCH₃ | |
| I-113 | CH₃ | N | OC₂H₅ | N(CH₃)₂ | |
| I-114 | CH₃ | N | OC₂H₅ | Cl | |
| I-115 | CH₃ | N | CH₃ | CH₃ | |
| I-116 | CH₃ | N | CH₃ | C₂H₅ | |
| I-117 | CH₃ | N | CH₃ | CF₃ | |
| I-118 | CH₃ | N | CH₃ | OCF₂H | |
| I-119 | CH₃ | N | CH₃ | NHCH₃ | |
| I-120 | CH₃ | N | CH₃ | N(CH₃)₂ | |
| I-121 | CH₃ | N | CH₃ | Cl | |
| I-122 | CH₃ | N | C₂H₅ | C₂H₅ | |
| I-123 | CH₃ | N | C₂H₅ | CF₃ | |
| I-124 | CH₃ | N | C₂H₅ | OCF₂H | |
| I-125 | CH₃ | N | C₂H₅ | NHCH₃ | |
| I-126 | CH₃ | N | C₂H₅ | Cl | |
| I-127 | CH₃ | N | CF₃ | CF₃ | |
| I-128 | CH₃ | N | CF₃ | OCF₂H | |
| I-129 | CH₃ | N | CF₃ | NHCH₃ | |
| I-130 | CH₃ | N | CF₃ | N(CH₃)₂ | |
| I-131 | CH₃ | N | CF₃ | Cl | |
| I-132 | CH₃ | N | OCF₂H | OCF₂H | |
| I-133 | CH₃ | N | OCF₂H | NHCH₃ | |
| I-134 | CH₃ | N | OCF₂H | N(CH₃)₂ | |
| I-135 | CH₃ | N | OCF₂H | Cl | |
| I-136 | CH₃ | N | NHCH₃ | NHCH₃ | |
| I-137 | CH₃ | N | NHCH₃ | N(CH₃)₂ | |
| I-138 | CH₃ | N | NHCH₃ | Cl | |
| I-139 | CH₃ | N | N(CH₃)₂ | N(CH₃)₂ | |
| I-140 | CH₃ | N | N(CH₃)₂ | Cl | |
| I-141 | CH₃ | N | Cl | Cl | |
| I-142 | H | N | N(CH₃)₂ | OCH₂CF₃ | 158 |
| I-143 | H | CH | Cl | OCH₂CF₃ | 204-205 |
| I-144 | H | CH | Cl | OCH₂CF₃ | |
| I-145 | H | CH | Cl | OCH₂CF₃ | 207⁽⁺⁾ |

For the purpose of the present invention, the pyridylsulfonylureas contained as component a) in the oil suspension concentrates according to the invention are in each case to be understood as meaning all use forms, such as acids, esters, salts and isomers, such as stereoisomers and optical isomers. Thus, in addition to neutral compounds, their salts for example with inorganic and/or organic counterions are in each case meant to be included. Thus, sulfonylureas are capable of forming salts, for example, in which the hydrogen of the —SO₂—NH— group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids. An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{z} is aminocarbonyl or aminosulfonyl, where the two last-mentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkylcarbonyl, phenylcarbonyl, where the phenyl ring may be substituted, or alkyloxycarbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Optionally substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl; alkynyl is, for example, propargyl, but-2-yn-1-yl, but-3-yn-1-yl, 1-methylbut-3-yn-1-yl. Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

The herbicides (a) inhibit the enzyme acetolactate synthase (ALS) and thus the protein synthesis in plants. The application rate of the herbicides (a) may vary within a wide range, for example between 0.001 g and 500 g of a.i./ha (hereinbelow, a.i./ha means “active ingredient per hectare”=based on 100% pure active compound). On applications using application rates of from 0.01 g to 200 g of a.i./ha of the herbicides (a), preferably the compounds I-1 to I-145, a relatively broad spectrum of harmful plants, for example of annual and perennial monocotyledonous or dicotyledonous weeds and also unwanted crop plants is controlled by the pre-emergence and the post-emergence method. In the combinations according to the invention, the application rates are generally lower, for example in the range of from 0.001 g to 100 g of a.i./ha, preferably from 0.005 g to 50 g of a.i./ha, particularly preferably from 0.01 g to 9 g of a.i./ha.

The herbicides (a) are suitable, for example, for controlling harmful plants in crop plants, for example in economically important farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as nontransgenic Glycine max. (for example conventional cultivars, such as STS cultivars) or transgenic Glycine max. (for example RR soybean or LL soybean) and crossbreeds thereof), Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevines, Hevea, bananas, sugar cane, coffee, tea, citrus fruit, nut plantations, lawn, palm plantations and forest plantations. For the use of herbicide combinations (a)+(e), these crops are likewise preferred. Of particular interest for the herbicide combinations (a)+(e4) are especially mutant crops tolerant to the herbicides (e4) and tolerant transgenic crops, preferably corn, rice, cereals, oilseed rape and soybean, in particular soybean, which are resistant to imidazolinone herbicides, glufosinate or glyphosate.

The herbicides (a) can also be employed nonselectively for controlling unwanted vegetation, for example in permanent crops and plantation crops, on roadsides, squares, industrial plants, airports or railway tracks, or for the bum-down application, for example in farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as nontransgenic Glycine max. (for example conventional cultivars, such as STS cultivars) or transgenic Glycine max. (for example RR-soybean or LL-soybean) and crossbreeds thereof, Phaseolus, Pisum, Vicia and Arachis, or vegetable crops from various botanical groups, such as potato, leek, cabbage, carrot, tomato, onion.

The oil suspension concentrates according to the invention comprise the herbicidally active compounds a) from the group of the pyridylsulfonylureas in general in amounts of from 0.01 to 50% by weight, preferably from 0.1 to 30% by weight; here and in the entire description, the term “% by weight” refers to the relative weight of the component in question based on the total weight of the formulation, unless defined otherwise.

Suitable organic solvents (component b) are, for example:

1) hydrocarbons, which may be unsubstituted or substituted, for example

1a) aromatic hydrocarbons, for example
mono- or polyalkyl-substituted benzenes, such as toluene, xylenes, mesitylene, ethylbenzene, or
mono- or polyalkyl-substituted naphthalenes, such as 1-methylnaphthalene, 2-methyinaphthalene or dimethyinaphthalene, or
other benzene-derived aromatic hydrocarbons, such as indane or Tetralin®, or
mixtures thereof,

1b) aliphatic hydrocarbons, for example
straight-chain or branched aliphatics, for example of the formula CₙH₂ₙ₊₂, such as pentane, hexane, octane, 2-methylbutane or 2,2,4-trimethylpentane, or
cyclic, optionally alkyl-substituted aliphatics, such as cyclohexane or methylcyclopentane, or
mixtures thereof, such as solvents of the Exxsol® D series, Isopar® series or Bayol® series, for example Bayol® 82 (ExxonMobil Chemicals), or the Isane® IP series or Hydroseal® G series (TotalFinaElf),

1c) mixtures of aromatic and aliphatic hydrocarbons, such as solvents of the Solvesso® series, for example Solvesso® 100, Solvesso® 150 or Solvesso® 200 (ExxonMobil Chemicals), of the Solvarex®/Solvaro® series (TotalFinaElf) or the Caromax® series, for example Caromax 28 (Petrochem Carless), or

1d) halogenated hydrocarbons, such as halogenated aromatic and aliphatic hydrocarbons, such as chlorobenzene or methylene chloride, or

2) polar solvents, for example aprotic polar solvents, such as fully etherified and fully esterified C₁-C₉-alkanoic acids which may be mono-, di- or polyfunctional, for example the ethers and esters with C₁-C₁₈-alkyl alcohols, ketones with a low tendency to tautomerize, phosphoric acid esters, amides, nitriles or sulfones, for example diisobutyl adipate, Rhodiasolv® RPDE (Rhodia), cyclohexanone, Jeffsol® PC (Huntsman), γ-butyrolactone, N-methylpyrrolidone, dimethyl sulfoxide, acetonitrile, tributylphosphatam or the Hostarex® PO series (Clariant), or protic polar solvents, such as alcohols, amines, carboxylic acids. The alcohols, amines or carboxylic acids preferably have 1 to 18 carbon atoms and can be straight-chain, branched or cyclic and saturated or unsaturated and may optionally comprise heteroatoms and be mono- or polyfunctional. Examples of alcohols are monohydric C₁-C₁₀-alcohols, such as methanol, ethanol, propanol, isopropanol, heptanol, octanol, isooctanol or phenol, or polyols, such as glycerol or polyglycols, commercially available, for example, as Exxal® series (ExxonMobil), Agrisynth® PA (ISP), Arcosolv® series (Lyondell Chemical) or Nacol® 6-98 (DEA). Examples of amines are diethylamine, hexylamine or aniline. Examples of carboxylic acids are adipic acid and adipic acid monoesters.

3) fatty acid esters, for example of natural origin, for example natural oils, such as animal oils or vegetable oils, or of synthetic origin, for example the Edenor® series, for example Edenor® MEPa or Edenor® MESU, or the Agnique®ME series or Agnique®AE series (Cognis), the Salim®ME series (Salim), the Radia® series, for example Radia®30167 (ICI), the Prilube® series, for example Prilube® 1530 (Petrofina), the Stepan® C series (Stepan) or the Witconol®23 series (Witco). The fatty acid esters are preferably esters of C₁₀-C₂₂—, with preference C₁₂-C₂₀—, fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid, and in particular C₁₈-fatty acids, such as stearic acid, oleic acid, linoleic acid or linolenic acid.

Examples of fatty acid esters such as C₁₀-C₂₂-fatty acid esters are glycerol and glycol esters of fatty acids such as C₁₀-C₂₂-fatty acids, or transesterification products thereof, for example fatty acid alkyl esters such as C₁₀-C₂₂-fatty acid C₁-C₂₀-alkyl esters, which can be obtained, for example, by transesterification of the abovementioned glycerol or glycol fatty acid esters such as C₁₀-C₂₂-fatty acid esters with C₁-C₂₀-alcohols (for example methanol, ethanol, propanol or butanol). The transesterification can be carried out by known methods, as described, for example, in Rompp Chemie Lexikon, 9th edition, volume 2, page 1343, Thieme Verlag Stuttgart.

Preferred fatty acid alkyl esters such as C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol fatty acid esters such as C₁₀-C₂₂-fatty acid esters are the uniform or mixed glycol esters and glycerol esters of C₁₀-C₂₂-fatty acids, in particular of such fatty acids having an even number of carbon atoms, for example erucic acid, lauric acid, palmitic acid and in particular C₁₈-fatty acids such as stearic acid, oleic acid, linoleic acid or linolenic acid.

Animal oils b) are generally known and commercially available. For the purpose of the present invention, the term “animal oils” is to be understood as meaning, for example, oils of animal origin such as whale oil, cod-liver oil, musk oil or mink oil.

Vegetable oils b) are generally known and commercially available. For the purpose of the present invention, the term “vegetable oils” is to be understood as meaning, for example, oils of oleaginous plant species, such as soybean oil, rapeseed oil, corn oil, sunflower oil, cottonseed oil, linseed oil, coconut oil, palm oil, thistle oil, walnut oil, arachis oil, olive oil or castor oil, in particular rapeseed oil, where the vegetable oils also include their transesterification products, for example alkyl esters, such as rapeseed oil methyl ester or rapeseed oil ethyl ester.

The vegetable oils are preferably esters of C₁₀-C₂₂—, preferably C₁₂-C₂₀—, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular C₁₈-fatty acids such as stearic acid, oleic acid, linoleic acid or linolenic acid.

Examples of vegetable oils are C₁₀-C₂₂-fatty acid esters of glycerol or glycol with C₁₀-C₂₂-fatty acids, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Rompp Chemie Lexikon, 9th edition, volume 2, page 1343, Thieme Verlag Stuttgart.

The vegetable oils can be contained in the oil suspension concentrates according to the invention for example in the form of commercially available vegetable oils, in particular rapeseed oils, such as rapeseed oil methyl ester, for example Phytorob® B (Novance, France), Edenor® MESU and the Agnique® ME series (Cognis, Germany), the Radia® series (ICI), the Prilube® series (Petrofina), or biodiesel or in the form of commercially available plant-oil-containing formulation additives, in particular those based on rapeseed oils, such as rapeseed oil methyl esters, for example Hasten® (Victorian Chemical Company, Australia, hereinbelow referred to as Hasten, main ingredient: rapeseed oil ethyl ester), Actirob® B (Novance, France, hereinbelow referred to as Actirob B, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

Examples of synthetic fatty acid esters are, for example, those derived from fatty acids having an odd number of carbon atoms, such as C₁₁-C₂₁-fatty acid esters.

Preferred organic solvents are aromatic hydrocarbons, aliphatic hydrocarbons and fatty acid esters, such as vegetable oils, such as triglycerides of fatty acids having 10 to 22 carbon atoms, which may be saturated or else unsaturated, straight-chain or branched and which may or may not carry further functional groups, such as corn oil, rapeseed oil, sunflower oil, cottonseed oil, linseed oil, soybean oil, coconut oil, palm oil, thistle oil or castor oil, and their transesterification products, such as fatty acid alkyl esters, and mixtures thereof.

The solvents may be present on their own or as a mixture. The solubilizing power of the solvent or solvent mixture used for the pyridylsulfonylurea(s) used (component a)) is preferably low.

The total proportion of solvents in the oil suspension concentrates according to the invention is generally between 5 and 95% by weight, preferably in the range between 20 and 80% by weight. The proportion of polar solvents such as aprotic polar solvents is generally below 20% by weight, preferably in the range from 0 to 10% by weight.

The oil suspension concentrates according to the invention comprise, as optional component c), safeners which are suitable for reducing or preventing damage to the crop plant. Suitable safeners are known, for example, from WO-A-96/14747 and the literature cited therein. In the organic solvent, the safeners can be present in suspended and/or dissolved form, preferably in dissolved form.

Suitable safeners are, for example, the following groups of compounds:
1) Compounds of the type of dichlorophenylpyrazoline-3-carboxylic acid (S1), preferably compounds such as ethyl 1-(2,4-dichlorophenyl)-5-(ethoxy-carbonyl)-5-methyl-2-pyrazoline-3-carboxylate (S1-1, mefenpyr-diethyl, PM pp. 781-782), and related compounds, as described in WO 91/07874.
2) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
3) Compounds of the type of the triazolecarboxylic acids, preferably compounds such as fenchlorazole, i.e. ethyl 1-(2,4-dichlorophenyl)-5-trichloro-methyl-(1H)-1,2,4-triazole-3-carboxylate (S1-6, fenchlorazole-ethyl, PM pp. 385-386), and related compounds (see EP-A-174 562 and EP-A-346 620).
4) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9, isoxadifen-ethyl) or n-propyl ester (S1-10) or ethyl 5-(4-fluorophenyl)-5-phenyl-2-isoxazoline-3-carboxylate (S1-11), as described in the patent application (WO-A-95/07897).
5) Compounds of the type of the 8-quinolineoxyacetic acid (S2), preferably 1-methylhex-1-yl (5-chloro-8-quinolineoxy)acetate (S2-1, cloquintocet-mexyl, PM pp. 263-264), 1,3-dimethylbut-1-yl (5-chloro-8-quinolineoxy)acetate (S2-2), 4-allyloxybutyl (5-chloro-8-quinolineoxy)acetate (S2-3), 1-allyloxyprop-2-yl (5-chloro-8-quinolineoxy)acetate (S2-4), ethyl (5-chloro-8-quinolineoxy)acetate (S2-5), methyl (5-chloro-8-quinolineoxy)acetate (S2-6), allyl (5-chloro-8-quinolineoxy)acetate (S2-7), 2-(2-propylideneiminooxy)-1-ethyl (5-chloro-8-quinolineoxy)acetate (S2-8), 2-oxoprbp-1-yl (5-chloro-8-quinolineoxy)acetate (S2-9) and related compounds, as described in EP-A-86 750, EP-A-94 349 and EP-A-191 736 or EP-A-0 492 366.
6) Compounds of the type of the (5-chloro-8-quinolineoxy)malonic acid, preferably compounds such as diethyl (5-chloro-8-quinolineoxy)malonate, diallyl (5-chloro-8-quinolineoxy)malonate, methyl ethyl (5-chloro-8-quinoline-oxy)malonate and related compounds, as described in EP-A-0 582 198.
7) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxy-propionic esters (mecoprop), MCPA or 3,6-dichloro-2-methoxybenzoic acid (esters) (dicamba).
8) Active compounds of the type of the pyrimidines, such as “fenclorim” (PM, pp. 512-511) (=4,6-dichloro-2-phenylpyrimidine).
9) Active compounds of the type of the dichloroacetamides, which are frequently used as pre-emergence safeners (soil-acting safeners), such as, for example, “dichlormid” (PM, pp. 363-364) (═N,N-diallyl-2,2-dichloroacetamide), “R-29148” (=3-dichloroacetyl-2,2,5-trimethyl-1,3-oxazolidone from Stauffer), “benoxacor” (PM, pp. 102-103) (=4-dichloroacetyl-3,4-dihydro-3-methyl-2H-1,4-benzoxazine, S4), “PPG-1292” (═N-allyl-N-[(1,3-dioxolan-2-yl)methyl]dichloroacetamide from PPG Industries), “DK-24” (═N-allyl-N-[(allylaminocarbonyl)methyl]dichloroacetamide from Sagro-Chem), “AD-67” or “MON 4660” (=3-dichloroacetyl-1-oxa-3-azaspiro[4,5]decane from Nitrokemia or Monsanto), “dicyclonon” or “BAS145138” or “LAB145138” (=(=3-dichloroacetyl-2,5,5-tri-methyl-1,3-diazabicyclo[4.3.0]nonane from BASF) and “furilazol” or “MON 13900” (see PM, 637-638) (=(RS)-3-dichloroacetyl-5-(2-furyl)-2,2-dimethyloxazolidone).
10) Active compounds of the type of the dichloroacetone derivatives, such as, for example, “MG 191” (CAS-Reg. No. 96420-72-3) (=2-dichloromethyl-2-methyl-1,3-dioxolane from Nitrokemia).
11) Active compounds of the type of the oxyimino compounds, which are known as seed dressings, such as, for example, “oxabetrinil” (PM, pp. 902-903) (=(Z)-1,3-dioxolan-2-ylmethoxyimino-(phenyl)acetonitrile), which is known as seed dressing safener against metolachlor damage, “fluxofenim” (PM, pp. 613-614) (=1-(4-chlorophenyl)-2,2,2-trifluoro-1-ethanone O-(1,3-dioxolan-2-ylmethyl) oxime which is known as seed dressing safener against metolachlor damage, and “cyometrinil” or “CGA43089” (PM, p. 1304) (=(Z)-cyanomethoxyimino-(phenyl)acetonitrile), which is known as seed dressing safener against metolachlor damage.
12) Active compounds of the type of the thiazolecarboxylic esters, which are known as seed dressings, such as, for example, “flurazole” (PM, pp. 590-591) (=benzyl 2-chloro-4-trifluoromethyl-1,3-thiazole-5-carboxylate), which is known as seed dressing safener against alachlor and metolachlor damage.
13) Active compounds of the type of the naphthalenedicarboxylic acid derivatives, which are known as seed dressings, such as, for example, “naphthalic anhydride” (PM, p. 1342) (=1,8-naphthalenedicarboxylic anhydride), which is known as seed dressing safener for corn against thiocarbamate herbicide damage.
14) Active compounds of the type of the chromanacetic acid derivatives, such as, for example, “CL 304415” (CAS-Reg. No. 31541-57-8) (=2-84-carboxychroman4-yl)acetic acid from American Cyanamid).
15) Active compounds which, in addition to a herbicidal action against harmful plants, also have safener action on crop plants such as, for example, “dimepiperate” or “MY-93” (PM, pp. 404-405) (═S-1-methyl-1-phenylethyl piperidine-1-thiocarboxylate), “daimuron” or “SK 23” (PM, p. 330) (=1-(1-methyl-1-phenylethyl)-3-p-tolyl-urea), “cumyluron”=“JC-940” (=3-(2-chlorophenylmethyl)-1-(1-methyl-1-phenyl-ethyl)urea, see JP-A-60087254), “methoxyphenone” or “NK 049” (=3,3′-dimethyl-4-methoxybenzophenone), “CSB” (=1-bromo-4-(chloromethylsulfonyl)benzene) (CAS-Reg No. 54091-06-4 from Kumiai).

Compounds of the type of the acylsulfamoylbenzoamides, for example of the formula (VIII) below, which are known, for example, from WO 99/16744.

| | |
|---|---|
| | (VIII) |
| 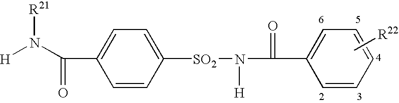 | |

| Compound No. | R²¹ | R²² |
|---|---|---|
| S3-1 | cyclopropyl | 2-OCH₃ |
| S3-2 | cyclopropyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

Preferred safeners are mefenpyr, fenchlorazole, isoxadifen, cloquintocet and their C₁-C₁₀-alkyl esters, and also the safeners (S3-1=4-cyclopropylaminocarbonyl-N-(2-methoxybenzoyl)benzenesulfonamide) and benoxacor (S-4), in particular mefenpyr-diethyl (S1-1), fenchlorazole-ethyl (S1-6), isoxadifen-ethyl (S1-9), cloquintocet-mexyl (S2-1), (S3-1) and benoxacor (S-4).

If the oil suspension concentrates according to the invention comprise safeners c), their proportion by weight is generally from 0.1 to 60% by weight, in particular from 2 to 40% by weight.

The weight ratio of component a) to component c) can vary within a wide range and is generally between 1:100 and 100:1, preferably between 1:10 and 10:1.

As optional agrochemically active compounds e), for example, agrochemically active compounds different from components a) and c), such as herbicides, fungicides, insecticides, plant growth regulators and the like, may be present. In the organic solvent, the agrochemically active compounds e) may be present in suspended and/or dissolved form.

Suitable agrochemically active compounds different from components (a) and (c), which active compounds are optionally present in the oil suspension concentrates according to the invention, are in particular herbicides, for example the known herbicides mentioned below as described, for example, in Weed Research 26, 441-445 (1986), or in “The Pesticide Manual”, 13th edition, The British Crop Protection Council, 2003, and the literature cited therein, for example in mixed formulations or as tank mix components. The compounds are referred to either by the “common name” according to the International Organization for Standardization (ISO) or by the chemical name, if appropriate together with a customary code number and in each case include all application forms, such as acids, salts, esters and isomers, such as stereoisomers and optical isomers: 2,4-D, acetochlor, acifluorfen, acifluorfen-sodium, aclonifen, alachlor, alloxydim, alloxydim-sodium, ametryn, amicarbazone, amidosulfuron, aminopyralid, amitrole, anilofos, asulam, atrazine, azafenidin, azimsulfuron, beflubutamid, benazolin,-benazolin-ethyl, benfuresate, bensulfuron-methyl, bentazone, benzfendizone, benzobicyclon, benzofenap, bifenox, bilanafos, bispyribac-sodium, bromacil, bromobutide, bromofenoxim, bromoxynil, butachlor, butafenacil, butenachlor, butralin, butroxydim, butylate, cafenstrole, carbetamide, carfentrazone-ethyl, chlomethoxyfen, chloridazon, chlorimuron-ethyl, chlornitrofen, chlorotoluron, chlorsulfuron, cinidon-ethyl, cinmethylin, cinosulfuron, clefoxydim, clethodim, clodinafop-propargyl, clomazone, clomeprop, clopyralid, cloransulam-ethyl, cumyluron, cyanazine, cyclosulfamuron, cycloxydim, cyhalofop-butyl, desmedipham, dicamba, dichlobenil, dichlorprop, dichlorprop-P, diclofop-methyl, diclosulam, difenzoquat, diflufenican, diflufenzopyr, dikegulac-sodium, dimefuron, dimepiperate, dimethachlor, dimethametryn, dimethenamid, diquat-dibromide, dithiopyr, diuron, dymron, EPTC, esprocarb, ethalfluralin, ethametsulfuron-methyl, ethofumesate, ethoxyfen, ethoxysulfuron, etobenzanid, fenoxaprop-ethyl, fenoxaprop-P-ethyl, fentrazamide, flamprop-M-isopropyl, flamprop-M-methyl, flazasulfuron, florasulam, fluazifop, fluazifop-butyl, fluazolate, flucarbazone-sodium, flucetosulfuron, fluchloralin, flufenacet, flufenpyr, flumetsulam, flumiclorac-pentyl, flumioxazin, fluometuron, fluorochloridone, fluoroglycofen-ethyl, flupoxam, flupyrsulfuron-methyl-sodium, fluridone, fluroxypyr, fluroxypyr-butoxypropyl, fluroxypyr-meptyl, flurprimidol, flurtamone, fluthiacet-methyl, fomesafen, foramsulfuron, glufosinate, glufosinate-ammonium, glyphosate, halosulfuron-methyl, haloxyfop, haloxyfop-ethoxyethyl, haloxyfop-methyl, haloxyfop-P-methyl, hexazinone, imazamethabenz-methyl, imazamox, imazapic, imazapyr, imazaquin, imazethapyr, imazosulfuron, indanofan, iodosulfuron-methyl-natrium, ioxynil, isoproturon, isouron, isoxaben, isoxachlortole, isoxaflutole, ketospiradox, lactofen, lenacil, linuron, MCPA, mecoprop, mecoprop-P, mefenacet, mesosulfuron-methyl, mesotrione, metamifop, metamitron, metazachlor, methabenzthiazuron, methyldymron, metobromuron, metolachlor, metosulam, metoxuron, metribuzin, metsulfuron-methyl, molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pendralin, penoxsulam, pentoxazone, pethoxamid, phenmedipham, picloram, picolinafen, pinoxaden, piperophos, pretilachlor, primisulfuron-methyl, profluazol, profoxydim, prometryn, propachlor, propanil, propaquizafop, propisochlor, propoxycarbazone-sodium, propyzamide, prosulfocarb, prosulfuron, pyraclonil, pyraflufen-ethyl, pyrazolate, pyrazosulfuron-ethyl, pyrazoxyfen, pyribenzoxim, pyributicarb, pyridafol, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsu Ifu ron, sethoxydim, simazine, simetryn, S-metolachlor, sulcotrione, sulfentrazone, sulfometuron-methyl, sulfosate, sulfosulfuron, tebuthiuron, tepraloxydim, terbuthylazine, terbutryn, thenylchlor, thiazopyr, thifensulfuron-methyl, thiobencarb, tiocarbazil, tralkoxydim, triallate, triasulfuron, triaziflam, tribenuron-methyl, triclopyr, tridiphane, trifloxysulfuron, trifluralin, triflusulfuron-methyl, tritosulfuron, 4-(4,5-di-hydro-4-methyl-5-oxo-3-trifluoromethyl-1H-1,2,4-triazol-1-yl)-2-(ethylsulfonylamino)-5-fluorobenzenecarbothioamide (HWH4991, cf. WO-A-95/30661), 2-chloro-N-[1-(2,6-dichloro-4-difluoromethylphenyl)-4-nitro-1H-pyrazol-5-yl]propanecarboxamide (SLA5599, cf. EP-A-303153), and the compounds

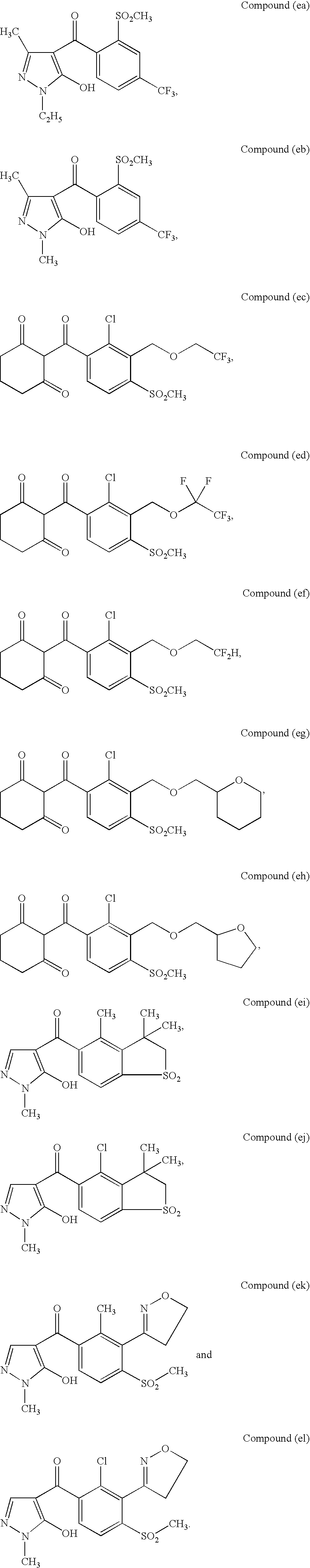

The compounds (ea) and (eb) are known from WO 01/74785, the active compounds (ec) to (eh) are known from WO 00/21924 and the other active compounds (ei) to (el) are known from WO 96/26206, WO 96/25412 and US 20020016262.

Preferred components e) are herbicides of the subgroups (e1) to (e4) below (most of the herbicides are referred to by the “common name”, if possible according to the reference “The Pesticide Manual”, British Crop Protection Council 1997, 11th ed., abbreviated “PM”, or 2003, 13th ed., abbreviated “PM13”):
(e1) herbicides which are active against monocotyledonous and dicotyledonous harmful plants, for example
   (e1.1) flufenacet (BAY FOE 5043) (PM, pp. 82-83), 4′-fluoro-N-isopropyl-2-(5-trifluoromethyl-1,3,4-thiadiazol-2-yloxy)acetanilide,
   (e1.2) metolachlor (PM, pp. 833-834), 2-chloro-N-(2-ethyl-6-methylphenyl)-N-(2-methoxy-1-methylethyl)acetamide,
   (e1.3) acetochlor (PM, pp. 10-12), 2-chloro-N-(ethoxymethyl)-N-(2-ethyl-6-methylphenyl)acetamide,
   (e1.4) dimethenamid (PM, pp. 409-410), 2-chloro-N-(2,4-dimethyl-3-thienyl)-N-(2-methoxy-1-methylethyl)acetamide,
   (e1.5) pethoxamid (AG Chem, New Compound Review (publ. Agranova), Vol. 17, 1999, p. 94, i.e. 2-chloro-N-(2-ethoxyethyl)-N-(2-methyl-1-phenyl-1-propenyl)acetamide,
   (e1.6) atrazine (PM, pp. 55-57), N-ethyl-N′-isopropyl-6-chloro-2,4-diamino-1,3,5-triazine,
   (e1.7) simazine (PM, pp. 1106-1108), 6-chloro-N,N-diethyl-2,4-diamino-1,3,5-triazine,
   (e1.8) cyanazine (PM, pp. 280-283), 2-(4-chloro-6-ethylamino-1,3,5-triazin-2-ylamino)-2-methylpropionitrile,
   (e1.9) terbuthylazine (PM, pp.1168-1170), N-ethyl-N′-tert-butyl-6-chloro-2,4-diamino-1,3,5-triazine,
   (e1.10) metribuzin (PM, pp. 840-841), 4-amino-6-tert-butyl-3-methylthio-1,2,4-triazin-5(4H)-one,
   (e1.11) terbutryn (PM, pp. 1170-1172), N-(1,1-dimethylethyl)-N′-ethyl-6-(methylthio)-1,3,5-triazine-2,4-diamine,
   (e1.12) nicosulfuron (PM, pp. 877-879), 2-(4,6-dimethoxypyrimidin-2-yl)-3-(3-dimethylcarbamoyl-2-pyridylsulfonyl)urea and its salts,
   (e1.13) rimsulfuron (PM, pp. 1095-1097), 1-(4,6-dimethoxypyrimidin-2-yl)-3-(3-ethylsulfonyl-2-pyridylsulfonyl)urea and its salts,
   (e1.14) primisulfuron and esters, such as the methyl ester (PM, pp. 997-999), 2-[4,6-bis(difluoromethoxy)pyrimidin-2-ylcarbamoylsulfamoyl]benzoic acid or methyl 2-[4,6-bis(difluoromethoxy)pyrimidin-2-ylcarbamoylsulfamoyl]benzoate, and their salts,
   (e1.15) halosulfuron (PM, pp. 657-659), 3-chloro-5-(4,6-dimethoxypyrimidin-2-ylcarbamoylsulfamoyl)-1-methylpyrazole4-carboxylic acid and its esters and salts, preferably the methyl ester,
   (e1.16) iodosulfuron (PM13, pp. 573-574) and, preferably, esters, such as the methyl ester, and salts thereof (cf. WO 96/41537 which is expressly included herein by way of reference), 4-iodo-2-(4-methoxy-6-methyl-1,3,5-triazin-2-ylcarbamoylsulfamoyl)benzoic acid or methyl 4-iodo-2-(4-methoxy-6-methyl-1,3,5-triazin-2-ylcarbamoylsulfamoyl)benzoate and their salts, such as the sodium salt, known from WO-A-92/13845, which is expressly incorporated herein by way of reference,
   (e1.17) foramsulfuron and its salts (PM13, pp. 494-495), 1-(4,6-dimethoxypyrimidin-2-yl)-3-[2-(dimethylcarbamoyl)-5-formamido-phenylsulfonyl]urea,
   (e1.18) pendimethalin (PM, pp. 937-939), N-(1-ethylpropyl)-2,6-dinitro-3,4-xylidine,
   (e1.19) sulcotrione (PM, pp. 1124-1125), 2-(2-chloro-4-mesyl-benzoyl)cyclohexane-1,3-dione,
   (e1.20) dicamba (PM, pp. 356-357), 3,6-dichloro-o-anisic acid and its salts,
   (e1.21) mesotrione, 2-(4-mesyl-2-nitrobenzoyl)cyclohexane-1,3-dione (ZA 1296, cf. Weed Science Society of America (WSSA) in WSSA Abstracts 1999, Vol. 39, pages 65-66, numbers 130-132),
   (e1.22) linuron (PM, pp. 751-753), 3-(3,4-dichlorophenyl)-1-methoxy-1-methylurea,
   (e1.23) isoxachlortole (AG Chem, New Compound Review, publ. Agranova, Vol. 16, 1998, p. 39), i.e. 4-chloro-2-(methylsulfonyl)phenyl 5-cyclopropylisoxazol-4-yl ketone,
   (e1.24) isoxaflutole (PM, pp. 737-739), (5-cyclopropylisoxazol-4-yl) 2-(methylsulfonyl)-4-(trifluoromethyl)phenyl methanone,
   (e1.25) metosulam (PM, pp. 836-838), 2′,6′-dichloro-5,7-dimethoxy-3′-methyl[1,2,4]triazolo[1,5-a]pyrimidine-2-sulfonamide,
   (e1.26) flumetsulam (PM, pp. 573-574), 2′,6′-difluoro-5-methyl[1,2,4]triazolo[1,5-a]pyrimidine-2-sulfonamide,
   (e1.27) cloransulam and esters, such as the methyl ester (PM, p. 265), 3-chloro-2-(5-ethoxy-7-fluoro[1,2,4]triazolo[1,5-c]pyrimidin-2-ylsulfonamido)benzoic acid and, preferably, the methyl ester,
   (e1.28) florasulam (Zeitschrift fur Pflanzenkrankheiten und Pflanzenschutz, Verlag Eugen Ulmer, Stuttgart, Special Edition XVI, 1998, pp. 527-534), N-(2,6-difluorophenyl)-8-fluoro-5-methoxy(1,2,4)triazolo[1,5-c]pyrimidine-2-sulfonamide,
   (e1.29) molinate (PM, pp. 847-849), N-(ethylthiocarbonyl)azepan,
   (e1.30) thiobencarb (PM, pp. 1192-1193), 4-chlorobenzyl N,N-diethyl-thiocarbamate,
   (e1.31) quinchlorac (PM, pp. 1078-1080), 3,7-dichloroquinoline-8-carboxylic acid and its salts,
   (e1.32) propanil (PM, pp.1017-1019), N-(3,4-dichlorophenyl)propanamide,
   (e1.33) pyribenzoxim, benzophenone O-[2,6-bis[(4,6-dimethoxy-2-pyrimidinyl)oxy]benzoyl]oxime, conference proceedings: The 1997 Brighton Crop Protection Conference, Weeds (publ. British Crop Protection Council) pp. 39-40,
   (e1.34) butachlor (PM, pp.159-160), N-(butoxymethyl)-2-chloro-N-(2,6-diethylphenyl)acetamide,
   (e1.35) pretilachlor (PM, pp. 995-996), N-(2-propoxyethyl)-2-chloro-N-(2,6-diethylphenyl)acetamide,
   (e1.36) clomazone (PM, pp. 256-257), 2-[(2-chlorophenyl)-4,4-dimethyl-3-isoxazolidinone,
   (e1.37) oxadiargyl (PM, pp. 904-905), 5-tert-butyl-3-[2,4-dichloro-5-(prop-2-ynyloxy)phenyl]-1,3,4-oxadiazol-2(3H)-one,
   (e1.38) oxaziclomefone, 3-[1-(3,5-dichlorophenyl)-1-methylethyl]-2,3-dihydro-6-methyl-5-phenyl-4H-1,3-oxazin4-one, conference proceedings: The 1997 Brighton Crop Protection Conference, Weeds (pubi. British Crop Protection Council) pp. 73-74,
   (e1.39) anilofos (PM, pp. 47-48), S4-chloro-N-isopropylcarbaniloylmethyl O,O-dimethyl phosphorodithioate,
   (e1.40) cafenstrole (PM, pp. 173-174), 1-diethylcarbamoyl-3-(2,4,6-trimethylphenylsulfonyl)-1,2,4-triazole,
   (e1.41) thiazopyr (PM, pp. 1185-1187), methyl 2-difluoromethyl-5-(4,5-dihydro-1,3-thiazol-2-yl)-4-isobutyl-6-trifluoromethyInicotinate,
   (e1.42) triclopyr (PM, pp. 1237-1239), [(3,5,6-trichloro-2-pyridinyl)oxy]acetic acid, preferably as triclopyr, triclopyr-butotyl, triclopyr-triethylammonium,
   (e1.43) oxadiazone (PM, pp. 905-907), 5-tert-butyl-3-(2,4-dichloro-5-isopropoxyphenyl)-1,3,4-oxadiazol-2(3H)-one,
   (e1.44) esprocarb (PM, pp. 472473), S-benzyl 1,2-dimethylpropyl-(ethyl)thiocarbamate,
   (e1.45) pyributicarb (PM, pp. 1060-1061), O-3-tert-butylphenyl-6-methoxy-2-pyridyl methylthiocarbamate (TSH-888),
   (e1.46) azimsulfuron (PM, pp. 63-65), 1-(4,6-dimethoxypyrimidin-2-yl)-3-[1-methyl-4-(2-methyl-2H-tetrazol-5-yl)pyrazol-5-yl]sulfonylurea,
   (e1.47) azoles, as known from EP-A-0663913, which is expressly incorporated herein by way of reference, for example 1-(3-chloro-4,5,6,7-tetrahydropyrazolo[1,5-a]pyridin-2-yl)-5-methylpropargylamino)-4-pyrazolylcarbonitrile (hereinbelow “EP 913”),
   (e1.48) thenylchlor (PM, pp. 1182-1183), 2-chloro-N-(3-methoxy-2-thenyl)-2′,6′-dimethylacetanilide,
   (e1.49) pentoxazone (PM, pp. 942-943), 3-(4-chloro-5-cyclopentyloxy-2-fluorophenyl)-5-isopropylidene-1,3-oxazolidine-2,4-dione,
   (e1.50) pyriminobac and its esters, such as the methyl ester (PM, pp. 1071-1072), methyl 2-(4,6-dimethoxy-2-pyrimidinyloxy)-6-(1-methoxyiminoethyl)benzoate, also as acid or sodium salt,
   (e1.51) mesosulfuron and its salts and esters (PM, p. 630), methyl 2-[(4,6-dimethoxypyrimidin-2-ylcarbamoyl)sulfamoyl]a-(methanesulfonamido)-p-toluate,
   (e1.52) isoproturon (PM, pp. 732-734), 3-(4-isopropylphenyl)-1,1-dimethylurea,
   (e1.53) chlortuloron (PM, pp. 229-231), 3-(3-chloro-p-tolyl)-1,1-dimethylurea,
   (e1.54) prosulfocarb (PM, pp. 1039-1041), S-benzyl dipropylthiocarbamate,
   (e1.55) flucarbazone and its salts (PM13, pp. 447448), 4,5-dihydro-3-methoxy-4-methyl-5-oxo-N-(2-trifluoromethoxyphenylsulfonyl)-1H-1,2,4-triazole-1-carboxamide sodium,
   (e1.56) propoxycarbazone and its salts (PM, pp. 831-832), methyl 2-[[[(4,5-dihydro-4-methyl-5-oxo-3-propoxy-1H-1,2,4-triazol-1-yl)carbonyl]amino]sulfonyl]benzoate, sodium salt,
   (e1.57) flupyrsulfuron and its esters, such as the methyl ester, and its salts (PM, pp. 586-588), methyl 2-(4,6-dimethoxypyrimidin-2-ylcarbamoylsulfamoyl)-6-trifluoromethyinicotinate sodium,
   (e1.58) sulfosulfuron and its salts (PM, pp.1130-1131), 1-(4,6-dimethoxypyrimidin-2-yl)-3-(2-ethylsulfonylimidazo[1,2-a]pyridin-3-yl)sulfonylurea,
   (e1.59) trifluralin (PM13, pp. 1012-1014), α,α,α-trifluoro-2,6-dinitro-N,N-dipropyl-p-toluidine,
   (e1.60) ethalfluralin (PM13, pp. 375-376), N-ethyl-a,o,a-trifluoro-N-(2-methylallyl)-2,6-dinitro-p-toluidine,
   (e1.61) norflurazon (PM13, pp. 711-712), 4-chloro-5-methylamino-2-(α,α,α-trifluoro-m-tolyl)pyridazin-3(2H)-one,
   (e1.62) vernolate (PM13, p.1099), S-propyl dipropylthiocarbamate,
   (e1.63) chlorotoluron (PM 13, p. 170), 3-(3-chloro-p-tolyl)-1,1-dimethylurea,
   (e1.64) imazethapyr and its salts and esters (PM1 3, pp. 558-560), (RS)-5-ethyl-2-(4-isopropyl4-methyl-5-oxo-2-imidazolin-2-yl)nicotinic acid,
   (e1.65) imazamox (PM13, pp. 552-553), (RS)-2-(4-isopropyl4-methyl-5-oxo-2-imidazolin-2-yl)-5-methoxymethylnicotinic acid,
   (e1.66) imazaquin and its salts and esters (PM13, pp. 557-558), (RS)-2-(4-isopropyl-4-methyl-5-oxo-2-imidazolin-2-yl)quinoline-3-carboxylic acid,
(e2) herbicides which are mainly active against dicotyledonous harmful plants, for example
   (e2.1) MCPA (PM, pp. 767-769), (4-chloro-2-methylphenoxy)acetic acid and its salts and esters,
   (e2.2) 2,4-D (PM, pp. 323-327), 2,4-dichlorophenoxyacetic acid and its salts and esters,
   (e2.3) bromoxynil (PM, pp. 149-151), 3,5-dibromo-4-hydroxybenzonitrile,
   (e2.4) bentazone (PM, pp. 1064-1066), 3-isopropyl-2,2-dioxo-1H-2,1,3-benzothiadiazin-4(3H)-one,
   (e2.5) fluthiacet (PM, pp. 606-608), [2-chloro4-fluoro-5-(5,6,7,8-tetrahydro-3-oxo-1H,3H-1,3,4-thiadiazolo[3,4-a]pyridazin-1-ylideneamino)phenylthio]acetic acid and, preferably, the methyl ester,
   (e2.6) pyridate (PM, pp.1064-1066), O-(6-chloro-3-phenylpyridazin-4-yl) S-(octyl) thiocarbonate,
   (e2.7) diflufenzopyr (BAS 654 00 H, PM pp. 81-82), 2-{1-[4-(3,5-difluorophenyl)semicarbazono]ethyl}nicotinic acid,
   (e2.8) carfentrazone (PM, pp.191-193), ethyl (RS)-2-chloro-3-[2-chloro-5-(4-difluoromethyl-4,5-dihydro-3-methyl-5-oxo-1 H-1,2,4-triazol-1-yl)-4-fluorophenyl]propionate, used, inter alia, as carfentrazone-ethyl (as stated) or else as acid,
   (e2.9) clopyralid (PM, pp. 260-263), 3,6-dichloropyridine-2-carboxylic acid,
   (e2.10) thifensulfuron and its esters, preferably the methyl ester (PM, pp.1188-1190), 3-[[[[(4-methoxy-6-methyl-1,3,5-triazin-2-yl)amino]-carbonyl]amino]sulfonyl]-2-thiophenecarboxylic acid or methyl 3-[[[[(4-methoxy-6-methyl-1,3,5-triazin-2-yl)amino]carbonyl]amino]sulfonyl]-2-thiophenecarboxylate and its salts,
   (e2.11) prosulfuron and its salts (PM, pp.1041-1043), 1-(4-methoxy-6-methyl-1,3,5-triazin-2-yl)-3-[2-(3,3,3-trifluoropropyl)phenylsulfonyl]urea and its salts,
   (e2.12) tritosulfuron and its salts (PM13, p. 1022; AG Chem, New Compound Review (publ. Agranova), Vol.17, 1999, p. 24), N-[[[4′-methoxy-6-(trifluoromethyl)-1,3,5-triazin-2-yl]amino]carbonyl]-2-trifluoromethylbenzenesulfonamide,
   (e2.13) triasulfuron and its salts (PM, pp. 1222-1224), 1-[2-(2-chloroethoxy)phenylsulfonyl]-3-(4-methoxy-6-methyl-1,3,5-triazin-2-yl)urea,
   (e2.14) 2,4-D (PM, pp. 323-327), (2,4-dichlorophenoxy)acetic acid, frequently used forms: 2,4-D-butotyl, 2,4-D-butyl, 2,4-D-dimethylammonium, 2,4-D-diolamine, 2,4-D-isooctyl, 2,4-D-isopropyl, 2,4-D-triolamine,
   (e2.15) MCPA (PM, pp. 770-771), (4-chloro-2-methylphenoxy)acetic acid, the forms that are mainly used are, inter alia, MCPA-butotyl, MCPA-dimethylammonium, MCPA-isoctyl, MCPA-potassium, MCPA-sodium,
   (e2.16) bensulfuron and its esters, preferably the methyl ester, and their salts (PM, pp. 104-105), methyl α-(4,6-dimethoxypyrimidin-2-yl-carbamoylsulfamoyl)-O-toluate,
   (e2.17) metsulfuron and its esters, preferably the methyl ester, and their salts (PM, pp., 842-844), methyl 2-[[[[(4-methoxy-6-methyl-1,3,5-triazin-2-yl)amino]carbonyl]amino]sulfonyl]benzoate,
   (e2.18) acifluorfen (PM, pp. 12-14), 5-(2-chloro-a,a,a-trifluoro-p-tolyloxy)-2-nitrobenzoic acid, also used as acifluorfen-sodium,
   (e2.19) bispyribac (KIH 2023), preferred is the form as sodium salt (PM, pp.129-131), sodium 2,6-bis[(4,6-dimethoxypyrimidin-2-yl)oxy]benzoate,
   (e2.20) ethoxysulfuron and its esters and salts (PM, pp. 488490), 1-(4,6-dimethoxypyrimidin-2-yl)-3-(2-ethoxyphenoxysulfonyl)urea,
   (e2.21) cinosulfuron and its esters and salts (PM, pp. 248-250), 1-(4,6-dimethoxy-1,3,5-triazin-2-yl)-3-[2-(2-methoxyethoxy)phenylsulfonyl]urea,
   (e2.22) pyrazosulfuron and its esters, preferably the ethyl ester, and their salts (PM, pp. 1052-1054), methyl 5-(4,6-dimethoxypyrimidin-2-ylcarbamoylsulfamoyl)-1-methylpyrazole4-carboxylate,
   (e2.23) imazosulfuron and its esters and salts (PM, pp. 703-704), 1-(2-chloroimidazo[1,2-a]pyridin-3-ylsulfonyl)-3-(4,6-dimethoxypyrimidin-2-yl)urea,
   (e2.24) cyclosulfamuron and its esters and salts (PM, pp. 288-289), N-[[[2-(cyclopropylcarbonyl)phenyl]amino]sulfonyl]-N 1-(4,6-dimethoxypyrimidin-2-yl)urea,
   (e2.25) chlorsulfuron and its esters and salts (PM, pp. 239-240), 1-(2-chlorophenylsulfonyl)-3-(4-methoxy-6-methyl-1,3,5-triazin-2-yl)urea,
   (e2.26) bromobutide (PM, pp.144-145), 2-bromo-3,3-dimethyl-N-(1-methyl-1-phenylethyl)butyramide,
   (e2.27) bentazone (PM, pp. 109-111), 3-isopropyl-1 H-2,1,3-benzothiadiazin-4(3H)-one 2,2-dioxide,
   (e2.28) chlorimuron and its esters, preferably the ethyl ester, and their salts (PM, pp. 217-218), ethyl 2-(4-chloro-6-methoxypyrimidin-2-yl-carbonylsulfamoyl)benzoate,
   (e2.29) diflufenican (PM, pp. 397-399), 2′,4′-difluoro-2-(α,α,α-trifluoro-m-tolyloxy)nicotinanilide,
   (e2.30) flurtamone (PM, pp. 602-603), (RS)-5-methylamino-2-phenyl-4-(α,α,α-trifluoro-m-tolyl)furan-3(2H)one,
   (e2.31) tribenuron (PM, pp. 1230-1232), methyl 2-[[[[4-methoxy-6-methyl-1,3,5-triazin-2-yl)methylamino]carbonyl]amino]sulfonyl]benzoate,
   (e2.32) amidosulfuron and its salts (PM, pp. 37-38), 1-(4,6-dimethoxypyrimidin-2-yl)-3-mesyl(methyl)sulfamoylurea,
   (e2.33) mecoprop/mecoprop-P and their esters (PM, pp. 776-779), (RS)-2-(4-chloro-o-tolyloxy)propionic acid,
   (e2.34) dichlorprop/dichlorprop-P and their esters (PM, pp. 368-372), (RS)-2-(2,4-dichlorophenoxy)propionic acid,
   (e2.35) fluroxypyr (PM, pp. 597-600), 4-amino-3,5-dichloro-6-fluoro-2-pyridyloxyacetic acid,
   (e2.36) picloram (PM, pp. 977-979), 4-amino-3,5,6-trichloropyridine-2-carboxylic acid,
   (e2.37) ioxynil (PM, pp. 718-721), 4-hydroxy-3,5-diiodobenzonitrile,
   (e2.38) bifenox (PM, pp. 116-117), methyl 5-(2,4-dichlorophenoxy)-2-nitrobenzoate,
   (e2.39) pyraflufen-ethyl (PM, pp. 1048-1049), ethyl 2-chloro-5-(4-chloro-5-difluoromethoxy-1-methylpyrazol-3-yl)-4-fluorophenoxyacetate,
   (e2.40) fluoroglycofen-ethyl (PM, pp. 580-582), O-[5-(2-chloro-α,α,α-trifluoro-p-tolyloxy)-2-nitrobenzoyl]glycolic acid,
   (e2.41) cinidon-ethyl (BAS 615005) (AG Chem, New Compound Review, publ. Agranova, Vol. 17, 1999, p. 26),
   (e2.42) picolinafen (PM13, pp. 785-786) (AG Chem, New Compound Review, (pubi. Agranova), Vol.17, 1999, p. 35), N-4-fluorophenyl-6-(3-trifluoromethylphenoxy)pyridine-2-carboxamide,
   (e2.43) sulfentrazone (PM13, pp. 910-911), 2′,4′-dichloro-5′-(4-difluoromethyl-4,5-dihydro-3-methyl-5-oxo-1H-1,2,4-triazol-1-yl)methanesulfonanilide,
   (e2.44) oxyfluorfen (PM13, pp. 738-739), 2-chloro-α,α,α-trifluoro-p-tolyl 3-ethoxy-4-nitrophenyl ether,
   (e2.45) lactofen (PM13, pp. 596-597), ethyl O-[5-(2-chloro-α,α,α-trifluoro-p-tolyloxy)-2-nitrobenzoyl]-DL-lactate,
   (e2.46) fomesafen (PM13, pp. 492-493), 5-(2-chloro-α,α,α-trifluoro-p-tolyloxy)-N-methylsulfonyl-2-nitrobenzamide,
   (e2.47) flumiclorac (PM13, pp. 460461), pentyl [2-chloro-5-(cyclohex-1-ene-1,2-dicarboximido)-4-fluorophenoxy]acetate,
   (e2.48) 2,4-DB (PM13, pp. 264-266), 4-(2,4-dichlorophenoxy)butyric acid,
   (e2.49) flumioxazin (PM13, pp. 461462), N-(7-fluoro-3,4-dihydro-3-oxo4-prop-2-ynyl-2H-1,4-benzoxazin-6-yl)cyclohex-1-ene-1,2-dicarboxamide,
   (e2.50) benazolin (PM13, pp. 62-64), 4-chloro-2-oxobenzothiazolin-3-ylacetic acid; 4-chloro-2,3-dihydro-2-oxobenzothiazol-3-ylacetic acid,
(e3) herbicides which are mainly active against monocotyledonous harmful plants, for example
   (e3.1) quizalofop/quizalofop-P and their esters, such as the ethyl or tefuryl ester (PM, pp.1087-1092), (RS)-2-[4-(6-chloroquinoxalin-2-yloxy)phenoxy]propionic acid,
   (e3.2) fenoxaprop/fenoxaprop-P and their esters, such as the ethyl ester (PM, pp. 519-520), ethyl 2-[4-(6-chlorobenzoxazol-2-yloxy)phenoxy]propionate,
   (e3.3) fluazifop/fluazifop-P and their esters, such as the butyl ester (PM, pp. 553-557), butyl (RS)-2-[4-(5-trifluoromethyl-2-pyridyloxy)phenoxy]propionate,
   (e3.4) haloxyfop/haloxyfop-P and their esters, such as the methyl ester (PM, pp. 659-663), (±)-2-[4-[[3-chloro-5-(trifluoromethyl)-2-pyridinyl]oxy]phenoxy]propionic acid including, inter alia, the application form as haloxyfop-etotyl, haloxyfop-methyl, haloxyfop-methyl [(R)-isomer],
   (e3.5) propaquizafop (PM, pp. 1021-1022), 2-isopropylideneaminooxyethyl (R)-2-[4-(6-chloroquinoxalin-2-yloxy)phenoxy]propionate,
   (e3.6) clodinafop and its esters, such as the propargyl ester (PM, pp. 251-253), (R)-2-[4-(5-chloro-3-fluoro-2-pyridyloxy)phenoxy]propionic acid,
   (e3.7) cyhalofop and its esters, such as the butyl ester (PM, pp. 297-298), butyl (R)-2-[4-(4-cyano-2-fluorophenoxy)phenoxy]propionate,
   (e3.8) diclofop/diclofop-P and their esters, such as the methyl ester (PM, pp. 374-377), (RS)-2-[4-(2,4-dichlorophenoxy)phenoxy]propionic acid,
   (e3.9) sethoxydim (PM, pp. 1101-1103), (+)-(EZ)-(1-ethoxyiminobutyl)-5-[2-(ethylthio)propyl]-3-hydroxycyclohex-2-enone,
   (e3.10) cycloxydim (PM, pp. 290-291), (±)-2-[1-(ethoxyimino)butyl]-3-hydroxy-5-thian-3-ylcyclohex-2-enone,
   (e3.11) clethodim (PM, pp. 250-251), (±)-2-[(E)-1-[(E)-3-chloroallyloxyimino]propyl]-5-[2-(ethylthio)propyl]-3-hydrocyclohex-2-enone,
   (e3.12) profoxydim, 2-[1-(2-(4-chlorophenoxy)propoxyimino)butyl]-3-oxo-5-thian-3-ylcyclohex-1-enol (AG Chem, New Compound Review (publ. Agranova), Vol. 17, 1999, p. 26 and PM, 13th edition pp. 808-809),
   (e3.13) alachlor (PM, pp. 23-24), 2-chloro-N-(2,6-diethylphenyl)-N-(methoxymethyl)acetamide,
   (e3.14) mefenacet (PM, pp. 779-781), 2-(1,3-benzothiazol-3-yloxy)-N-methylacetanilide,
   (e3.15) fentrazamide, N-cyclohexyl-N-ethyl-4-(2-chlorophenyl)-5-oxo4,5-dihydrotetrazole-1-carboxamide (PM13, pp. 427-428 and conference proceedings: The 1997 Brighton Crop Protection Conference, Weeds (pubi. British Crop Protection Council), pp. 67-68),
   (e3.16) benfuresate (PM, pp. 98-99), 2,3-dihydro-3,3-dimethylbenzofuran-5-yl ethanesulfonate,
(e4) herbicides which are active against monocotyledonous and dicotyledonous harmful plants, for use in the nonselective field or in specifically tolerant crops, such as
   (e4.1) glufosinate (PM, pp. 643-645), also including glufosinate-P, for example 4-[hydroxy(methyl)phosphinoyl]-DL-homoalanine, 4-[hydroxy(methyl)phosphinoyl]-L-homoalanine, in each case preferably as salts, for example ammonium or alkali metal salts, such as
      (e4.1.1) glufosinate-ammonium,
      (e4.1.2) glufosinate-P-ammonium,
      (e4.1.3) glufosinate-sodium,
      (e4.1.4) glufosinate-P-sodium,
   (e4.2) glyphosate (PM, pp. 646-649), N-(phosphonomethyl)glycine and its salts and esters, for example
      (e4.2.1) glyphosate-isopropylammonium,
      (e4.2.2) glyphosate-sesquisodium,
      (e4.2.3) glyphosate-trimesium,
   (e4.3) paraquat and its salts, such as paraquat dichloride (PM pp. 923-925).
Imidazolinones and their salts, such as
   (e4.4) imazapyr and its salts and esters (PM, pp. 697-699),
   (e4.5) imazamethabenz and its salts and esters (PM, pp. 694-696),
   (e4.6) imazamethabenz-methyl (PM, pp. 694-696),
   (e4.7) imazapic (AC 263,222) and its salts and esters, for example the ammonium salt, (PM, pp. 5 and 6, referred to under AC 263,222).

Suitable combination partners (e) are preferably compounds which are selective in soybeans, for example
(eα) herbicides which act selectively against monocotyledonous and dicotyledonous harmful plants in soybeans, for example
   (e1.59) trifluralin (PM, pp. 1248-1250),
   (e1.10) metribuzin (PM, pp. 840-841),
   (e1.36) clomazone (PM, pp. 256-257),
   (e1.18) pendimethalin (PM, pp. 937-939),
   (e1.2) metolachlor (PM, pp. 833-834),
   (e1.26) flumetsulam (PM, pp. 573-574),
   (e1.4) dimethenamid (PM, pp. 409-410),
   (e1.22) linuron (PM, pp. 751-753),
   (e1.60) ethalfluralin (PM, pp. 473-474),
   (e1.1) flufenacet (BAY FOE 5043) (PM, pp. 82-83),
   (e1.61) norflurazon (PM, pp. 886-888),
   (e1.62) vernolate (PM, pp. 1264-1266),
   (e1.63) chlortoluron, chlorotoluron (PM, pp. 229-231),
   (e1.27) cloransulam and esters, such as the methyl ester (PM, p. 265),
   (e1.64) imazethapyr (PM 13, pp. 558-560),
   (e1.65) imazamox (PM13, pp. 552-553),
   (e1.66) imazaquin (PM13, pp. 557-558),
(eβ) herbicides which act selectively against dicotyledonous harmful plants in soybeans, for example
   (e2.43) sulfentrazone (PM, pp.1126-1127),
   (e2.4) bentazone (PM, pp. 109-111),
   (e2.10) thifensulfuron and its esters, in particular the methyl ester (PM, pp. 1188-1190),
   (e2.44) oxyfluorfen (PM, pp. 919-921),
   (e2.45) lactofen (PM, pp. 747-748),
   (e2.46) fomesafen (PM, pp. 616-618),
   (e2.47) flumiclorac (PM, pp. 575-576) and its esters, such as the pentyl ester,
   (e2.18) acifluorfen and its sodium salt (PM, pp.12-14),
   (e2.48) 2,4-DB (PM, pp. 337-339) and its esters and salts,
   (e2.49) flumioxazin (PM13, pp. 461-462),
   (e2.50) benazolin (PM13, pp. 62-64),
   (e2.2) 2,4-D (PM, pp. 323-327) and its esters and salts,
   (e2.28) chlorimuron and its esters and salts, such as chlorimuron-ethyl,
(eγ) herbicides which act selectively against monocotyledonous harmful plants in soybeans, for example
   (e3.9) sethoxydim (PM, pp. 1101-1103),
   (e3.10) cycloxydim (PM, pp. 290-291),
   (e3.11) clethodim (PM, pp. 250-251),
   (e3.1) quizalofop-P and its esters, such as the ethyl or tefuryl ester (PM, pp. 1089-1092),
   (e3.2) fenoxaprop-P and its esters, such as the ethyl ester (PM, pp. 519-520),
   (e3.3) fluazifop-P and its esters, such as the butyl ester (PM, pp. 556-557),
   (e3.4) haloxyfop and haloxyfop-P and their esters, such as the methyl or the etotyl ester (PM, pp. 660-663),
   (e3.5) propaquizafop (PM, pp. 1021-1022),
   (e3.13) alachlor (PM, pp. 23-24),
(eδ) nonselective herbicides which can be used in soybeans for specific purposes, for example
   (e4.1) glufosinate (PM, pp. 643-645),
   (e4.2) glyphosate (PM, pp. 646-649),
   (e4.3) paraquat (salts), such as paraquat dichloride (PM, pp. 923-925).

Combination partners (e) which are also preferred are benozalin, fenoxaprop, lactofen, chlortoluron, flufenacet, metribuzin, benfuresate, fentrazamide, mefenacet, diclofop, ioxynil, bromoxynil, amidosulfuron, flurtamone, diflufenican, ethoxysulfuron, flucarbazone, propoxycarbazone, sulcotrione, mesotrione, isoproturon, iodosulfuron, mesosulfuron, foramsulfuron, anilofos, oxaziclomefone, oxadiargyl, isoxaflutole, linuron.

If, in the context of this description, the short form of the “common name” is used, this embraces all customary derivatives, such as the esters and salts, and isomers, in particular optical isomers, in particular the commercial form or forms. The stated chemical compound names refer to at least one of the compounds embraced by the “common name”, frequently to a preferred compound. Also included in the case of sulfonylureas are salts which are formed by exchanging a hydrogen atom at the sulfonamide group by a cation.

Preference is given to herbicidal combinations comprising one or more herbicides (a) and one or more herbicides (e), preferably from the group (e1) or (e2), (e3) or (e4). More preferred are combinations of herbicides (a) with one or more herbicides (e) according to the scheme: (a)+(e1), (a)+(e2), (a)+(e3), (a)+(e4), (a)+(e1)+(e2), (a)+(e1)+(e3), (a)+(e1)+(e4), (a)+(e2)+(e3), (a)+(e2)+(e4), (a)+(e3)+(e4) or (a)+(e1)+(e2)+(e3).

Combinations according to the invention include those combinations which additionally comprise one or more further agrochemically active compounds different from herbicides [active compounds (c)], such as safeners (for example mefenpyrdiethyl, isoxadifen-ethyl, cloquintocet-mexyl, 1,8-naphthalic anhydride, dichlormid, benoxacor, fenclorim, furilazole or N-cyclopropyl-4-[(2-methoxybenzoyl)sulfamoyl]benzamide (see WO 99/16744), insecticides or fungicides, such as (a)+(e1)+(c), (a)+(e2)+(c) or (a)+(e3)+(c), (a)+(e4)+(c), (a)+(e1)+(e2)+(c), (a)+(e1)+(e3)+(c), (a)+(e1)+(e4)+(c), (a)+(e2)+(e3)+(c), (a)+(e2)+(e4)+(c), (a)+(e3)+(e4)+(c) or (a)+(e1)+(e2)+(e3)+(c).

The preferred conditions illustrated below in particular for two-component combinations according to the invention apply primarily also to combinations comprising three or more active compounds, if they comprise the two-component combinations according to the invention, and with respect to the two-component combination in question.

The application rates of the herbicides (e) may vary considerably depending on the herbicide. The following quantities [in g of a.i. (active ingredient)/ha (hectare)] may be used as guidelines for preferred application rates for some mixing partners of group (e), where in the combinations according to the invention even amounts of less than the lowest amount may be appropriate:

Herbicides of group (e1): 10-8000, preferably 50-5000 g of a.i./ha,

Herbicides of group (e2): 5-5000, preferably 2-2500 g of a.i./ha,

Herbicides of group (e3): 10-500, preferably 25-300 g of a.i./ha,

Herbicides of group (e4): 20-5000, preferably 100-2000 g of a.i./ha.

Ranges of suitable ratios of the compounds (a) and (e) follow, for example, from the application rates mentioned for the individual compounds. In general, in the combinations according to the invention, the application rates may be reduced. Preferred mixing ratios (a):(e) for the combinations according to the invention are listed below:

(a): (e1)=10:1 to 1:800 000, preferably 6:1 to 1:500 000,

(a): (e2)=200:1 to 1:500 000, preferably 5:1 to 1:250 000,

(a): (e3)=10:1 to 1:500 000, preferably 5:1 to 1:250 000,

(a): (e4)=5:1 to 1:500 000, preferably 1:10 to 1:200 000.

If the oil suspension concentrates according to the invention comprise agrochemically active compounds e), their proportion by weight is generally from 0.5 to 50% by weight, in particular from 3 to 20% by weight.

The total content of active compounds (sum of components a)+c)+e)) contained in the oil suspension concentrates according to the invention is generally between 1 and 80% by weight, in particular between 2 and 60% by weight.

The oil suspension concentrates according to the invention may optionally comprise sulfosuccinates (component d), for example mono- or diesters of sulfosuccinic acid, preferably those of the formula (II)
R¹—(X₁)ₙ—O—CO—CH₂—CH(SO₃M)—CO—O—(X₂)ₘ—R² (II)
in which
R¹ is H or an unsubstituted or substituted C₁-C₃₀-hydrocarbon radical, such as C₁-C₃₀-alkyl or C₇-C₃₀-alkylaryl,
R² is H or an unsubstituted or substituted C₁-C₃₀-hydrocarbon radical, such as C₁-C₃₀-alkyl or C₇-C₃₀-alkylaryl, or a cation, for example a metal cation, such as an alkali metal or alkaline earth metal cation, or an ammonium cation, such as NH₄ or an alkyl-, alkylaryl- or poly(arylalkyl)-phenylammonium cation,
X¹, X² are identical or different and independently of one another are a spacer unit, such as a polyether unit or a polyester unit,
n, m are identical or different and independently of one another are zero or 1 preferably zero, and
M is a cation, for example a metal cation, such as an alkali metal or alkaline earth metal cation, or an ammonium cation, such as NH₄ or an alkyl-, alkylaryl- or poly(arylalkyl)phenylammonium cation.

Preference is given to sulfosuccinates of the formula (II) in which R¹ and R² are identical or different and independently of one another are linear, branched or cyclic, saturated or unsaturated C₁-C₂₀—, preferably C₄-C₁₈—, alkyl radicals, such as methyl, ethyl, butyl, hexyl, cyclohexyl, octyl, such as 2-ethylhexyl, decyl, tridecyl or octadecyl radicals, or R¹ and R² are C₇-C₂₀-alkylaryl radicals, such as nonylphenyl, 2,4,6-tri-sec-butylphenyl, 2,4,6-tris(1-phenylethyl)phenyl, alkylbenzyl or a hydrocinnamic radical,

X₁ and X₂ are identical or different and independently of one another are polyether units, such as polyethylene glycols —(C₂H₄O)ₚ— or polypropylene glycols —(C₃H₆O)ₚ— where p=1 to p=20, in particular p=1 to p=12, or polyester units, such as polyhydroxybutyric acid —(CH[CH₃]—CH₂—COO)_{q}— or polylactic acid —(CH[CH₃]—COO)_{q}— where q=1 to q=15, in particular q=1 to q=8, n, m are identical or different and independently of one another are zero or 1, preferably zero, and M is a cation, for example a metal cation, such as an alkali metal or alkaline earth metal cation, or an ammonium cation which may be alkyl-substituted.

Examples of sulfosudccinates present according to the invention are
a1) sulfosuccinate which is esterified once or twice with linear, cyclic or branched. aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,
a2) sulfosuccinate which is esterified once or twice with (poly)alkylene oxide adducts of alcohols, having, for example, 1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol +2-5 mol of ethylene oxide or with i-tridecyl +3 mol of ethylene oxide,
a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,
a4) the dialkali metal salt, preferably the disodium salt, of maleic anhydride which has been reacted with one equivalent of an amide or a (poly)alkylene oxide adduct of an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of oleylamide +2 mol of ethylene oxide and then sulfonated, and/or
a5) the tetraalkali metal salt, preferably the tetrasodium salt, of N-(1,2-dicarboxy-ethyl)-N-octadecylsulfosuccinamate.

Examples of sulfosuccinates of groups a1) to a5) which are commercially available and preferred within the context of the present invention are listed below:
a1) sodium dialkylsulfosuccinate, for example sodium di-(C₄-C₁₈)-alkylsulfosuccinate, such as sodium diisooctylsulfosuccinate, preferably sodium di(2-ethylhexyl)sulfosuccinate, commercially available, for example, in the form of the Aerosol brands (Cytec), the Agrilan or Lankropol® brands (Akzo Nobel), the Empimin® brands (Albright&Wilson), the Cropol® brands (Croda), the Lutensit® brands (BASF), the Triton® brands (Union Carbide), the Geropon® brands (Rhodia) or the Imbirol®, Madeol® or Polirol® brands (Cesalpinia),
a2) sodium alcohol polyethylene glycol ether sulfosuccinate, commercially available, for example, in the form of Geropon® ACR brands (Rhodia),
a3) disodium alcohol polyethylene glycol ether semisulfosuccinate, commercially available, for example, in the form of the Aerosol® brands (Cytec), the Marlinat® or Sermul® brands (Condea), the Empicol® brands (Albright&Wilson), the Secosol® brands (Stepan), the Geropon® brands (Rhodia), the Disponil® or Texapon® brands (Cognis) or the Rolpon® brands (Cesalpinia),
a4) disodium N-alkylsulfosuccinamate, commercially available, for example, in the form of the Aerosol® brands (Cytec), the Rewopol® or Rewoderm® brands (Rewo), the Empimine brands (Albright&Wilson), the Geropon® brands (Rhodia) or the Polirol® brands (Cesalpinia),
a5) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and
a6) tetrasodium N-(1,2-dicarboxyethyl)-N-octadecylsulfosuccinamate, commercially available, for example, in the form of Aerosol 22® (Cytec).

Sulfosuccinates are commercially available, for example, as Aerosol® (Cytec), Agrilan® or Lankropol® (Akzo Nobe1), Empimin® (Huntsman), Cropol® (Croda), Lutensite (BASF), Triton® GR series (UnionCarbide), Imbirol®/Madeol®/Polirol® (Cesalpinia); as Geropon®AR series or as Geropon® SDS (Rhodia).

Preferred sulfosuccinates are, for example, the sodium, potassium and ammonium salts of bis(alkyl)sulfosuccinates, where the alkyl radicals are identical or different and contain 4 to 16 carbon atoms and are, preferably, butyl, hexyl, octyl, such as 2-ethylhexyl, or decyl radicals, which may be straight-chain or branched. Particular preference is given to sodium di(C₄-C₁₀-alkyl)sulfosuccinate such as sodium di(2-ethylhexyl)sulfosuccinate.

If the oil suspension concentrates according to the invention comprise sulfosuccinates d), their proportion by weight is generally 0.5 to 60% by weight, in particular 1 to 30% by weight.

The inorganic salts (component f) optionally contained in the oil suspension concentrates according to the invention are preferably basic inorganic salts. These are to be understood as meaning salts which, in 1% strength aqueous solution, have a pH>7, preferably weakly basic salts having a pH between 7 and 11. Examples of such salts are carbonates, bicarbonates, hydroxides, oxides, hypochlorites and sulfites, preferably carbonates and bicarbonates. As cations, the inorganic salts preferably contain metal ions, in particular alkali metal, alkaline earth metal and transition metal ions, preferably alkali metal and alkaline earth metal ions, such as sodium, potassium, magnesium or calcium. Particularly preferred salts are alkali metal salts, in particular alkali metal carbonates and alkali metal bicarbonates, such as Na₂CO₃, K₂CO₃, NaHCO₃ and KHCO₃. The inorganic salts may be present on their own or in a mixture.

If the oil suspension concentrates according to the invention contain inorganic salts f), their proportion by weight is generally from 0.01 to 20% by weight, preferably from 0.01 to 10% by weight, particularly preferably from 0.05 to 5% by weight.

Customary auxiliaries and additives (component g) which may also be contained in the oil suspension concentrates according to the invention are, for example: surfactants, such as emulsifiers and dispersants, thickeners and thixotropic agents, wetting agents, anti-drift agents, adhesives, penetrants, preservatives and antifreeze agents, antioxidants, solubilizers, fillers, carriers and colorants, antifoams, fertilizers, evaporation inhibitors and agents which modify pH and viscosity.

Suitable emulsifiers and dispersants are, for example, nonionic emulsifiers and dispersants, for example:
1) polyalkoxylated, preferably polyethoxylated, saturated and unsaturated aliphatic alcohols,
   having 8 to 24 carbon atoms in the alkyl radical, which is derived from the corresponding fatty acids or from petrochemical products, and
   having 1 to 100, preferably 2 to 50, ethylene oxide units (EO), it being possible for the free hydroxyl group to be alkoxylated,
   which are commercially available, for example, as Genapol® X and Genapol® O series (Clariant), Crovol® M series (Croda) or as Lutensol® series (BASF),
2) polyalkoxylated, preferably polyethoxylated, arylalkylphenols, such as, for example, 2,4,6-tris(1-phenylethyl)phenol (tristyrylphenol) having an average degree of ethoxylation of between 10 and 80, preferably from 16 to 40, such as, for example, Soprophor® BSU (Rhodia) or HOE S 3474 (Clariant),
3) polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, Arkopal® N series or Sapogenat® T series (Clariant),
4) polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the Emulsogen® EL series (Clariant) or the Agnique® CSO series (Cognis),
5) polyalkoxylated, preferably polyethoxylated, sorbitan esters, such as, for example, Atplus® 309 F (Uniqema) or the Alkamuls® series (Rhodia),
6) polyalkoxylated, preferably polyethoxylated, amines, such as, for example, Genamin® series (Clariant), Imbentin® CAM series (Kolb) or Lutensol® FA series (BASF),
7) di- and tri-block copolymers, for example from alkylene oxides, for example from ethylene oxide and propylene oxide, having average molar masses between 200 and 10 000, preferably from 1000 to 4000, g/mol, the proportion by mass of the polyethoxylated block varying between 10 and 80%, such as, for example, the Genapol® PF series (Clariant), the Pluronic® series (BASF), or the Synperonic® PE series (Uniqema).

Preferred nonionic emulsifiers and dispersants are, for example, polyethoxylated alcohols, polyethoxylated triglycerides which contain hydroxyfatty acids and polyethylene oxide/polypropylene oxide block copolymers.

If the oil suspension concentrates according to the invention contain nonionic emulsifiers and dispersants, their proportion by weight is generally from 1 to 20% by weight.

Also suitable are ionic emulsifiers and dispersants, for example:
1) polyalkoxylated, preferably polyethoxylated, emulsifiers/dispersants (cf. component e) which are ionically modified, for example by conversion of the terminal free hydroxyl function of the polyethylene oxide block into a sulfate or phosphate ester (for example as alkali metal and alkaline earth metal salts), such as, for example, Genapol® LRO or dispersant 3618 (Clariant), Emulphor® (BASF) or Crafol® AP (Cognis),
2) alkali metal and alkaline earth metal salts of alkylarylsulfonic acids having a straight-chain or branched alkyl chain, such as phenylsulfonate CA or phenylsulfonate CAL (Clariant), Atlox® 3377BM (ICl), or the Empiphos® TM series (Huntsman),
3) polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet® D425 (Witco), the Kraftsperse® series (Westvaco) or the Borresperse® series (Borregard).

Preferred ionic emulsifiers/dispersants are, for example, salts of alkylarylsulfonic acids and polyelectrolytes from the polycondensation of naphthalenesulfonate and formaldehyde.

If the oil suspension concentrates according to the invention contain ionic emulsifiers and dispersants, their proportion by weight is generally from 0.1 to 20% by weight, in particular from 0.5 to 8% by weight.

If nonionic or ionic emulsifiers and dispersants are used not only because of their emulsifying/dispersing properties but also to increase the biological effectiveness, for example as penetrants or tackifiers, their proportion in the oil suspension concentrates according to the invention may be increased to up to 60% by weight.

Suitable thickeners and thixotropic agents are, for example:
1) modified natural silicates, such as chemically modified bentonites, hectorites, attapulgites, montmorillonites, smectites or other silicate minerals, such as Bentone® (Elementis), Attagel® (Engelhard), Agsorb® (Oil-Dri Corporation) or Hectorite® (Akzo Nobel),
2) synthetic silicates, such as silicates of the Sipernat®, Aerosil® or Durosil® series (Degussa), the CAB-O-SIL® series (Cabot) or the Van Gel series (R.T. Vanderbilt),
3) thickeners based on synthetic polymers, such as thickeners of the Thixin® or Thixatrol® series (Elementis),
4) thickeners based on natural polymers and natural oils, for example from the Thixin® or Thixatrol® series (Elementis).

Preferred thickeners and thixotropic agents are, for example, modified phyllosilicates and thickeners based on synthetic polymers.

If the oil suspension concentrates according to the invention contain thickeners and thixotropic agents, their proportion by weight is generally from 0.1 to 5% by weight, in particular from 0.2 to 3% by weight.

Preference is given to oil suspension concentrates according to the invention comprising:
a) from 0.01 to 50% by weight, preferably from 0.1 to 30% by weight, of one or more herbicidally active compounds from the group of the pyridylsulfonylureas, preferably dioxazinepyridylsulfonylureas, in particular those of the formula (I) and/or salts thereof,
b) from 5 to 95% by weight, preferably from 20 to 80% by weight, of one or more solvents,
c) optionally from 0.1 to 60% by weight, preferably from 2 to 40% by weight, of one or more safeners,
d) optionally from 0.5 to 60% by weight, preferably from 1 to 30% by weight, of one or more sulfosuccinates,
e) optionally from 0.5 to 50% by weight, preferably from 3 to 20% by weight, of one or more agrochemically active compounds different from a) and c),
f) optionally from 0.01 to 20% by weight, preferably from 0.01 to 10% by weight, of one or more inorganic salts,
g) optionally from 1 to 20% by weight of one or more nonionic emulsifiers and dispersants,
   optionally from 1 to 20% by weight of one or more ionic emulsifiers and dispersants,
   optionally from 0.1 to 5% by weight, preferably from 0.2 to 3% by weight, of one or more thickeners and thixotropic agents.

In a preferred embodiment, the oil suspension concentrate according to the invention comprises
a) one or more herbicidally active compounds of the formula (I) and/or their salts, preferably I-1 to I-145,
b) one or more organic solvents from the group of the aliphatic or aromatic hydrocarbons and the vegetable oils, such as rapeseed oil methyl ester, and
c) one or more sulfosuccinates, preferably di(C₄-C₁₆-alkyl)sulfosuccinates, such as sodium di(2-ethylhexyl)sulfosuccinate, and/or
d) one or more inorganic salts.

Particularly preferred examples which may be mentioned are oil suspension concentrates according to the invention comprising the components listed below; however, this does not limit the invention. Here, Solvesso is a solvent from the Solvesso® series, preferably Solvesso®200, Bayol is a solvent from the Bayol® series, preferably Bayol®82, Edenor=Edenor®MESU and Actirob=Actirob®B.

Solvesso+I-1, Bayol+I-1, Edenor+I-1, Actirob B+I-1, Solvesso+I-2, Bayol+I-2, Edenor+I-2, Actirob B+I-2, Solvesso+I-3, Bayol+I-3, Edenor+I-3, Actirob B+I-3, Solvesso+I-4, Bayol+I-4, Edenor+I-4, Actirob B+I-4, Solvesso+I-5, Bayol+I-5, Edenor+I-5, Actirob B+I-5, Solvesso+I-6, Bayol+I-6, Edenor+I-6, Actirob B+I-6, Solvesso+I-7, Bayol+I-7, Edenor+I-7, Actirob B+I-7, Solvesso+I-8, Bayol+I-8, Edenor+I-8, Actirob B+I-8, Solvesso+I-9, Bayol+I-9, Edenor+I-9, Actirob B+I-9, Solvesso+I-10, Bayol+I-10, Edenor+I-10, Actirob B+I-10 Solvesso+I-11, Bayol+I-11, Edenor+I-11, Actirob B+I-11, Solvesso+I-12, Bayol+I-12, Edenor+I-12, Actirob B+I-12, Solvesso+I-1 3, Bayol+I-1 3, Edenor+I-13, Actirob B+I-13, Solvesso+I-14, Bayol+I-14, Edenor+I-14, Actirob B+I-14, Solvesso+I-15, Bayol+I-15, Edenor+I-15, Actirob B+I-15, Solvesso+I-16, Bayol+I-16, Edenor+I-16, Actirob B+I-16, Solvesso+I-17, Bayol+I-17, Edenor+I-17, Actirob B+I-17, Solvesso+I-18, Bayol+I-18, Edenor+I-18, Actirob B+I-18, Solvesso+I-19, Bayol+I-19, Edenor+I-19, Actirob B+I-19, Solvesso+I-20, Bayol+I-20, Edenor+I-20, Actirob B+I-20, Solvesso+I-21, Bayol+I-21, Edenor+I-21, Actirob B+I-21, Solvesso+I-22, Bayol+I-22, Edenor+I-22, Actirob B+I-22, Solvesso+I-23, Bayol+I-23, Edenor+I-23, Actirob B+I-23, Solvesso+I-24, Bayol+I-24, Edenor+I-24, Actirob B+I-24, Solvesso+I-25, Bayol+I-25, Edenor+I-25, Actirob B+I-25, Solvesso+I-26, Bayol+I-26, Edenor+I-26, Actirob B+I-26, Solvesso+I-27, Bayol+I-27, Edenor+I-27, Actirob B+I-27, Solvesso+I-28, Bayol+I-28, Edenor+I-28, Actirob B+I-28, Solvesso+I-29, Bayol+I-29, Edenor+I-29, Actirob B+I-29, Solvesso+I-30, Bayol+I-30, Edenor+I-30, Actirob B+I-30, Solvesso+I-31, Bayol+I-31, Edenor+I-31, Actirob B+I-31, Solvesso+I-32, Bayol+I-32, Edenor+I-32, Actirob B+I-32, Solvesso+I-33, Bayol+I-33, Edenor+I-33, Actirob B+I-33, Solvesso+I-34, Bayol+I-34, Edenor+I-34, Actirob B+I-34, Solvesso+I-35, Bayol+I-35, Edenor+I-35, Actirob B+I-35, Solvesso+I-36, Bayol+I-36, Edenor+I-36, Actirob B+I-36, Solvesso+I-37, Bayol+I-37, Edenor+I-37, Actirob B+I-37, Solvesso+I-38, Bayol+I-38, Edenor+I-38, Actirob B+I-38, Solvesso+I-39, Bayol+I-39, Edenor+I-39, Actirob B+I-39, Solvesso+I-40, Bayol+I-40, Edenor+I-40, Actirob B+I-40, Solvesso+I-41, Bayol+I-41, Edenor+I-41, Actirob B+I-41, Solvesso+I-42, Bayol+I-42, Edenor+I-42, Actirob B+I-42, Solvesso+I-43, Bayol+I-43, Edenor+I-43, Actirob B+I-43, Solvesso+I-44, Bayol+I-44, Edenor+I-44, Actirob B+I-44, Solvesso+I-45, Bayol+I-45, Edenor+I-45, Actirob B+I-45, Solvesso+I-46, Bayol+I-46, Edenor+I-46, Actirob B+I-46, Solvesso+I-47, Bayol+I-47, Edenor+I-47, Actirob B+I-47, Solvesso+I-48, Bayol+I-48, Edenor+I-48, Actirob B+I-48, Solvesso+I-49, Bayol+I-49, Edenor+I-49, Actirob B+I-49, Solvesso+I-50, Bayol+I-50, Edenor+I-50, Actirob B+I-50, Solvesso+I-51, Bayol+I-51, Edenor+I-51, Actirob B+I-51, Solvesso+I-52, Bayol+I-52, Edenor+I-52, Actirob B+I-52, Solvesso+I-53, Bayol+I-53, Edenor+I-53, Actirob B+I-53, Solvesso+I-54, Bayol+I-54, Edenor+I-54, Actirob B+I-54, Solvesso+I-55, Bayol+I-55, Edenor+I-55, Actirob B+I-55, Solvesso+I-56, Bayol+I-56, Edenor+I-56, Actirob B+I-56, Solvesso+I-57, Bayol+I-57, Edenor+I-57, Actirob B+I-57, Solvesso+I-58, Bayol+I-58, Edenor+I-58, Actirob B+I-58, Solvesso+I-59, Bayol+I-59, Edenor+I-59, Actirob B+I-59, Solvesso+I-60, Bayol+I-60, Edenor+I-60, Actirob B+I-60, Solvesso+I-61, Bayol+I-61, Edenor+I-61, Actirob B+I-61, Solvesso+I-62, Bayol+I-62, Edenor+I-62, Actirob B+I-62, Solvesso+I-63, Bayol+I-63, Edenor+I-63, Actirob B+I-63, Solvesso+I-64, Bayol+I-64, Edenor+I-64, Actirob B+I-64, Solvesso+I-65, Bayol+I-65, Edenor+I-65, Actirob B+I-65, Solvesso+I-66, Bayol+I-66, Edenor+I-66, Actirob B+I-66, Solvesso+I-67, Bayol+I-67, Edenor+I-67, Actirob B+I-67, Solvesso+I-68, Bayol+I-68, Edenor+I-68, Actirob B+I-68, Solvesso+I-69, Bayol+I-69, Edenor+I-69, Actirob B+I-69, Solvesso+I-70, Bayol+I-70, Edenor+I-70, Actirob B+I-70, Solvesso+I-71, Bayol+I-71, Edenor+I-71, Actirob B+I-71, Solvesso+I-72, Bayol+I-72, Edenor+I-72, Actirob B+I-72, Solvesso+I-73, Bayol+I-73, Edenor+I-73, Actirob B+I-73, Solvesso+I-74, Bayol+I-74, Edenor+I-74, Actirob B+I-74, Solvesso+I-75, Bayol+I-75, Edenor+I-75, Actirob B+I-75, Solvesso+I-76, Bayol+I-76, Edenor+I-76, Actirob B+I-76, Solvesso+I-77, Bayol+I-77, Edenor+I-77, Actirob B+I-77, Solvesso+I-78, Bayol+I-78, Edenor+I-78, Actirob B+I-78, Solvesso+I-79, Bayol+I-79, Edenor+I-79, Actirob B+I-79, Solvesso+I-80, Bayol+I-80, Edenor+I-80, Actirob B+I-80, Solvesso+I-81, Bayol+I-81, Edenor+I-81, Actirob B+I-81, Solvesso+I-82, Bayol+I-82, Edenor+I-82, Actirob B+I-82, Solvesso+I-83, Bayol+I-83, Edenor+I-83, Actirob B+I-83, Solvesso+I-84, Bayol+I-84, Edenor+I-84, Actirob B+I-84, Solvesso+I-85, Bayol+I-85, Edenor+I+I-85, Actirob B+I-85, Solvesso+I-86, Bayol+I-86, Edenor+I-86, Actirob B+I-86, Solvesso+I-87, Bayol+I-87, Edenor+I-87, Actirob B+I-87, Solvesso+I-88, Bayol+I-88, Edenor+I-88, Actirob B+I-88, Solvesso+I-89, Bayol+I-89, Edenor+I-89, Actirob B+I-89, Solvesso+I-90, Bayol+I-90, Edenor+I-90, Actirob B+I-90, Solvesso+I-91, Bayol+I-91, Edenor+I-91, Actirob B+I-91, Solvesso+I-92, Bayol+I-92, Edenor+I-92, Actirob B+I-92, Solvesso+I-93, Bayol+I-93, Edenor+I-93, Actirob B+I-93, Solvesso+I-94, Bayol+I-94, Edenor+I-94, Actirob B+I-94, Solvesso+I-95, Bayol.+I-95, Edenor+I-95, Actirob B+I-95, Solvesso+I-96, Bayol+I-96, Edenor+I-96, Actirob B+I-96, Solvesso+I-97, Bayol+I-97, Edenor+I-97, Actirob B+I-97, Solvesso+I-98, Bayol+I-98, Edenor+I-98, Actirob B+I-98, Solvesso+I-99, Bayol+I-99, Edenor+I-99, Actirob B+I-99, Solvesso+I-100, Bayol+I-100, Edenor+I-100, Actirob B+I-100, Solvesso+I-101, Bayol+I-101, Edenor+I-101, Actirob B+I-101, Solvesso+I-102, Bayol+I-102, Edenor+I-102, Actirob B+I-102, Solvesso+I-103, Bayol+I-103, Edenor+I-103, Actirob B+I-103, Solvesso+I-104, Bayol+I-104, Edenor+I-104, Actirob B+I-104, Solvesso+I-105, Bayol+I-105, Edenor+I-105, Actirob B+I-105, Solvesso+I-106, Bayol+I-106, Edenor+I-106, Actirob B+I-106, Solvesso+I-107, Bayol+I-107, Edenor+I-107, Actirob B I-107, Solvesso+I-108, Bayol+I-108, Edenor+I-108, Actirob B+I-108, Solvesso+I-109, Bayol+I-109, Edenor+I-109, Actirob B+I-109, Solvesso+I-110, Bayol+I-110, Edenor+I-110, Actirob B+I-110, Solvesso+I-111, Bayol+I-111, Edenor+I-111, Actirob B+I-111, Solvesso+I-112, Bayol+I-1 12, Edenor+I-1 12, Actirob B+I-112, Solvesso+I-113, Bayol+I-113, Edenor+I-113, Actirob B+I-113, Solvesso+I-114, Bayol+I-114, Edenor+I-114, Actirob B+I-114, Solvesso+I-115, Bayol+I-115, Edenor+I-115, Actirob B+I-115, Solvesso+I-116, Bayol+I-116, Edenor+I-116, Actirob B+I-116, Solvesso+I-117, Bayol+I-117, Edenor+I-117, Actirob B+I-117, Solvesso+I-118, Bayol+I-118, Edenor+I-118, Actirob B+I-118, Solvesso+I-119, Bayol+I-119, Edenor+I-119, Actirob B+I-119, Solvesso+I-120, Bayol+I-120, Edenor+I-120, Actirob B+I-120, Solvesso+I-121, Bayol+I-121, Edenor+I-121, Actirob B+I-121, Solvesso+I-122, Bayol+I-122, Edenor+I-122, Actirob B+I-122, Solvesso+I-123, Bayol+I-123, Edenor+I-123, Actirob B+I-123, Solvesso+I-124, Bayol+I-124, Edenor+I-124, Actirob B+I-124, Solvesso+I-125, Bayol+I-125, Edenor+I-125, Actirob B+I-125, Solvesso+I-126, Bayol+I-126, Edenor+I-126, Actirob B+I-126, Solvesso+I-127, Bayol+I-127, Edenor+I-127, Actirob B+I-127, Solvesso+I-128, Bayol+I-128, Edenor+I-128, Actirob B+I-128, Solvesso+I-129, Bayol+I-129, Edenor+I-129, Actirob B+I-129, Solvesso+I-130, Bayol+I-130, Edenor+I-130, Actirob B+I-130, Solvesso+I-131, Bayol+I-131, Edenor+I-131, Actirob B+I-131, Solvesso+I-132, Bayol+I-132, Edenor+I-132, Actirob B+I-132, Solvesso+I-133, Bayol+I-133, Edenor+I-133, Actirob B+I-133, Solvesso+I-134, Bayol+I-134, Edenor+I-134, Actirob B+I-134, Solvesso+I-135, Bayol+I-135, Edenor+I-135, Actirob B+I-135, Solvesso+I-136, Bayol+I-136, Edenor+I-136, Actirob B+I-136, Solvesso+I-137, Bayol+I-137, Edenor+I-137, Actirob B+I-137, Solvesso+I-138, Bayol+I-138, Edenor+I-138, Actirob B+I-138, Solvesso+I-139, Bayol+I-139, Edenor+I-139, Actirob B+I-139, Solvesso+I-140, Bayol+I-140, Edenor+I-140, Actirob B+I-140, Solvesso+I-141, Bayol+I-141, Edenor+I-141, Actirob B+I-141, Solvesso+I-142, Bayol+I-142, Edenor+I-142, Actirob B+I-142, Solvesso+I-143, Bayol+I-143, Edenor+I-143, Actirob B+I-143, Solvesso+I-144, Bayol+I-144, Edenor+I-144, Actirob B+I-144, Solvesso+I-145, Bayol+I-145, Edenor+I-145, Actirob B+I-145.

The combinations mentioned above preferably comprise one or more sulfosuccinates d), in particular sodium di(2-ethylhexyl)sulfosuccinate.

All of the above combinations may also comprise one or more safeners (c), in particular those selected from the group consisting of (S1-1), (S1-6), (S1-9), (S2-1), (S3-1), (S-4), and/or one or more agrochemically active compounds (e), in particular those selected from the groups consisting of (e1.1)-(e1.66), (e2.1)-(e2.50), (e3.1)-(e3.16), (e4.1)-(e4.7).

The above combinations may furthermore also comprise one or more inorganic salts f), and also customary auxiliaries and additives g).

If the oil suspension concentrates according to the invention comprise, as component a), a plurality of pyridylsulfonylureas, for example mixtures of pyridylsulfonylureas of the formula (I) and/or their salts, at least one of the pyridylsulfonylureas is present in suspended form, but it is also possible for all pyridylsulfonylureas to be present in suspended form.

The oil suspension concentrates according to the invention can be prepared by known processes, for example by mixing the components. Thus, it is possible, for example, to prepare a premix by dissolving the optional sulfosuccinate d) in the organic solvent b) and, if appropriate, adding further auxiliaries and additives g) to this solution. Any soluble agrochemically active compounds c) and e) used are then dissolved in the premix. Once the dissolution process has ended, solid pyridylsulfonylurea a) and, if appropriate, any insoluble active compounds c) and e) used and also inorganic salts f) are suspended in the mixture. The coarse suspension is, if appropriate after pregrinding, subjected to fine grinding.

In another embodiment, solid pyridylsulfonylurea a) and, if appropriate, any insoluble components c), e), f) and g) used are suspended in the organic solvent b) which optionally contains a sulfosuccinate d) and subjected to grinding. Any soluble active compounds c) and e) used and any auxiliaries and additives from g) which do not require grinding or are not required for the grinding process are added after grinding.

To prepare the mixtures, it is possible to use customary mixing apparatus which, if required, are thermostatted. For pregrinding, it is possible to use, for example, high-pressure homogenizers or mills operating by the rotor-stator principle, such as Ultraturrax homogenizers, for example those from IKA, or toothed colloid mills, for example from Puck. For fine grinding, it is possible to use, for example, bead mills which operate batchwise, for example from Drais, or bead mills which operate continuously, for example from Bachofen. The preparation process can be adapted to the properties of the components optionally pretreated and to technical and safety requirements and to economical considerations, and pregrinding and even fine grinding of the suspension may be dispensed with, if required.

The components a) to f) used for the preparation may comprise water as a minor component which is then also found in the oil suspension concentrates according to the invention. Accordingly, the oil suspension concentrates according to the invention may comprise small amounts of water, in general from 0 to 5% by weight. Preferably, the oil suspension concentrates according to the invention are not subjected to any drying.

For use, the oil suspension concentrates according to the invention may, if appropriate, be diluted in a customary manner (for example using water), to give, for example, suspensions, emulsions, suspoemulsions or solutions, preferably to give emulsions. It may be advantageous to add further agrochemically active compounds (for example tank mix partners in the form of corresponding formulations) and/or auxiliaries and additives customary for application, for example self-emulsifying oils, such as vegetable oils or paraffin oils, and/or fertilizers to obtained spray emulsions. Accordingly, the present invention also provides such herbicidal compositions based on the oil suspension concentrates according to the invention.

The oil suspension concentrates according to the invention and the use forms obtainable therefrom by dilution (all of which are referred to as “herbicidal compositions according to the invention”) have outstanding herbicidal activity against a broad spectrum of economically important monocotyledonous and dicotyledonous harmful plants, including species which are resistant to herbicidally active compounds such as glyphosate, glufosinate, atrazine or imidazolinone herbicides. The active compounds also act efficiently on perennial weeds which produce shoots from rhizomes, rootstocks or other perennial organs and which are difficult to control. The substances can be applied, for example, by the pre-sowing, the pre-emergence or the post-emergence method. Preferred is, for example, the application to the emerged harmful plants (for example weeds or unwanted crop plants), in particular prior to the emergence of the (wanted) crop plants.

Specific examples which may be mentioned are some representatives of the monocotyledonous and dicotyledonous weed flora which can be controlled by the compounds according to the invention, without the enumeration being a restriction to certain species.

The compositions act efficiently against, from amongst the monocotyledonous weed species, for example Avena spp., Alopecurus spp., Brachiaria spp., Digitaria spp., Lolium spp., Echinochloa spp., Panicum spp., Phalaris spp., Poa spp., Setaria spp. and also Cyperus species from the annual group and, from amongst the perennial species, Agropyron, Cynodon, Imperata and Sorghum and also perennial Cyperus species.

In the case of dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

If the herbicidal compositions according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the herbicidal compositions are applied post-emergence to the green parts of the plants, growth likewise stops drastically a very short time after the treatment and the weed plants remain at the growth stage at the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active compounds in the combinations according to the invention is advantageous. A particular advantage is that the dosages of the compounds (a), which are used in the combinations and are effective, can be adjusted to such a low quantity that their soil action is optimally low. Not only does this allow them to be employed in sensitive crops in the first place, but groundwater contaminations are also virtually avoided. The active compound combination according to the invention allows the application rate of the active compounds required to be reduced considerably.

The abovementioned properties and advantages are of benefit for weed control practice to keep agricultural crops free from undesired competing plants and thus to safeguard and/or increase the yields from the qualitative and quantitative points of view. These novel combinations markedly exceed the technical state of the art with a view to the properties described.

In addition, some of the compositions according to the invention have outstanding growth-regulatory properties in crop plants. They engage in the plant's metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without destroying the plants at the same time. Inhibition of vegetative growth is very important in a large number of monocotyledonous and dicotyledonous crops since yield losses caused by lodging can thus be reduced, or prevented completely.

By virtue of their herbicidal and plant-growth-regulatory properties, the compositions can be employed for controlling harmful plants in known crop plants or still to be developed tolerant or genetically modified crop plants. The transgenic plants are distinguished as a rule by particular, advantageous properties, such as, in addition to resistances to the compositions according to the invention, for example resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:
the modification, by recombinant technology, of crop plants with the aim of modifying the starch synthesized in the plants (for example WO 92/11376, WO 92/14827, WO 91/19806),
transgenic crop plants which exhibit resistances to other herbicides, for example to sulfonylureas (EP-A-0257993, U.S. Pat. No. 5,013,659),
transgenic crop plants with the capability of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene und Klone”, VCH Weinheim 2^{nd} Edition 1996 or Christou, “Trends in Plant Science” 1 (1996) 423-431.

To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribozyme which specifically cleaves transcripts of the abovementioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

Thus, the present invention furthermore provides a method for controlling unwanted plants, preferably in crop plants, which comprises applying the herbicidal compositions according to the invention to the plants (for example harmful plants, such as monocotyledonous or dicotyledonous weeds or unwanted crop plants), the seed or the area on which the plants grow (for example the area under cultivation).

Unwanted plants are to be understood as meaning all plants which grow in locations where they are unwanted. This can, for example, be harmful plants (for example monocotyledonous or dicotyledonous weeds or unwanted crop plants), including, for example, those which are resistant to certain herbicidally active compounds, such as glyphosate, atrazine, glufosinate or imidazolinone herbicides.

In the method according to the invention, an effective amount of the herbicidal compositions according to the invention is preferably employed for controlling harmful plants, preferably in crop plants, for example in economically important farm crops, for example monocotyledonous farm crops, for example cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. such as nontransgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevine, Hevea, bananas, sugar cane, coffee, tea, citrus fruits, nut plantations, lawn, palm plantations and forest plantations.

The herbicidal compositions according to the invention have excellent selectivity in crops of leguminous plants. They are suitable, for example, for the selective control of unwanted vegetation, for example of harmful plants (for example monocotyledonous and dicotyledonous weeds or unwanted crop plants), in crops of transgenic and nontransgenic leguminous plants, in particular of the genus Glycine, for example by the pre-sowing method, the pre-emergence method or the post-emergence method.

Suitable leguminous plants are, for example, transgenic and nontransgenic leguminous plants, for example of the genera Glycine, Phaseolus, Pisum, Vicia and Arachis. Preferred are leguminous plants of the genus Glycine, for example of the species Glycine max. (soybean), such as nontransgenic Glycine max. (for example conventional cultivars, such as STS cultivars) or transgenic Glycine max. (for example RR-soybeans or LL-soybeans) and crossbreeds thereof.

The herbicidal compositions according to the invention can also be employed non-selectively for controlling unwanted vegetation, for example in permanent crops and plantation crops, on roadsides, squares, industrial plants, airports or railway tracks, or for the burn-down application, for example in farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as nontransgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion. The application is preferably carried out to the emerged harmful plants (for example weeds or unwanted crop plants), in particular prior to the emergence of (wanted) crop plants.

Permanent crops and plantation crops are, for example, pome fruit and stone fruit, berry fruit, grapevines, Hevea, bananas, sugar cane, coffee, tea, citrus fruit, nut plantations, roses, palm plantations and forest plantations.

Preferred for the nonselective application is the burn-down application in crop plants, where the herbicidal compositions according to the invention are applied to the emerged harmful plants prior to the emergence of the crop plants; preference is given here to application prior to sowing of the crop plants or during sowing of the crop plants.

The invention also provides the use of the herbicidal compositions according to the invention for controlling unwanted vegetation, preferably in crop plants.

To control unwanted plant growth (for example for the nonselective control of harmful plants or for the selective control of harmful plants in leguminous plants), the herbicidal compositions according to the invention can be applied to the plants (for example (wanted) crop plants or harmful plants, such as monocotyledonous or dicotyledonous weeds or unwanted crop plants), the seed (for example grains, seeds or vegetative propagation organs, such as tubers or shoot parts with buds) or to the area on which the plants grow (for example the area under cultivation), in particular in a herbicidally effective amount. They can be applied, for example, prior to sowing, and also both before and after emergence of the plants. Pre-sowing application can be carried out, for example, by spraying or incorporation into the soil. Split applications, for example early pre-emergence followed by later post-emergence application, are also possible. Preference is given to application to the emerged harmful plants (for example monocotyledonous or dicotyledonous weeds or unwanted crop plants), in particular prior to the emergence of (wanted) crop plants, such as leguminous plants.

For the selective use in leguminous plants, application to emerged plants, in particular to emerged harmful plants (for example weeds or unwanted crop plants) is preferred, preferably prior to the emergence of the leguminous plants. Preferred for the nonselective use is the application to the emerged harmful plants (for example weeds or unwanted crop plants). In the burn-down application, application is preferably carried out prior to sowing or during sowing of the crop plants, to the emerged harmful plants.

The amount of active compound applied may vary within a relatively wide range. It depends essentially on the nature of the desired effect. In general, the application rates are between 0.01 g and 100 g of active compound per hectare of soil surface. For selective use, preference is generally given to lower application rates, for example in the range from 0.01 g to 9 g of active compound per hectare, preferably between 0.1 g and 5 g per hectare, in particular in the application to emerged plants, in particular to emerged harmful plants (for example weeds or unwanted crop plants). Preferred for the nonselective use are generally application rates in the range from 0.01 g to 49 g of active compound per hectare, in particular from 0.01 g to 9 g of active compound per hectare, preferably between 0.1 g and 5 g per hectare.

The oil suspension concentrate of the present invention has excellent chemical stability during preparation and storage and is suitable in particular also for combinations of active compounds having different physical chemical properties, for example of a herbicidal pyridylsulfonylurea which is poorly soluble in organic solvents with further soluble agrochemically active compounds. Moreover, the oil suspension concentrate has excellent physical stability, is easy to apply and easy to use and has high biological effectiveness and crop plant compatibility (selectivity).

The oil suspension concentrates described in the examples below were prepared as follows: a premix was prepared in which all the soluble components from d), f) and g) and also, if appropriate, the thickener were homogeneously distributed in the solvent or solvent mixture b). Soluble active compounds c) and e) were then dissolved in the premix. Following conclusion of the dissolution process, solid pyridylsulfonylurea a) and further insoluble components from c) to g) were suspended in the mixture. The coarse suspension was, after pregrinding, subjected to fine grinding.

The abbreviations used in the examples below have, unless already defined, the following meanings:

| | |
|---|---|
| Compound I-1 = | compound No. I-1 from Table 1 |
| Emcol ® P 18.60 = | branched calcium dodecylbenzenesulfonate, |
| | Akzo Nobel |
| Genamin ® T-200 = | ethoxylated alkylamine having 20 ethylene oxide |
| | units, Clariant |
| Genapol ® X060 = | polyethoxylated isotridecanol having 6 ethylene |
| | oxide units, Clariant |
| Genapol ® V4739 = | polyethoxylated isotridecanol having 6 ethylene |
| | oxide units, methoxy-capped, Clariant |
| Solvesso ® 200 = | aromatic mineral oil (boiling range 219-281° C.), |
| | Exxon |
| Thixatrol ® ST = | organic castor oil derivative, Elementis |
| Triton ® GR-7M E = | di(2-ethylhexyl)sulfosuccinate sodium salt in |
| | aromatic solvent, Union Carbide |

### EXAMPLES

Preparation and storage of oil suspension concentrates (all data in % by weight)

TABLE A

| | Example | | | | |
|---|---|---|---|---|---|
| | 1 | 2 | 3 | 4 | 5 |
| Compound I-1 | 2.13 | 2.08 | 2.11 | 2.07 | 10.13 |
| Solvesso ® 200 | 55.12 | 55.17 | 55.89 | 45.93 | 47.87 |
| Triton ® GR-7M E | 30.00 | 30.00 | 30.00 | 30.00 | 30.00 |
| Genapol ® X060 | 10.00 | — | — | — | — |
| Genapol ® V4739 | — | 10.00 | 10.00 | 10.00 | 10.00 |
| Emcol ® R 18.60 | 2.00 | 2.00 | 2.00 | 2.00 | 2.00 |
| Thixatrol ® ST | 0.75 | 0.75 | — | — | — |
| Genamin ® T-200 | — | — | — | 10.00 | — |

Examples 1 to 5 were repeated using, instead of compound No. I-1, the compounds Nos. I-3, I-8, I-9, I-10, I-11, I-12, I-14, I-21, I-22, I-23, I-29, I-30, I-51, I-52, I-60, I-70, I-142, I-143, I-145 from Table 1 (examples 6 to 100). The formulations of examples 1 to 100 were stored at 40° C. for 8 weeks, during which time they were storage-stable (determined by HPLC).

1. An oil suspension concentrate comprising
a) one or more herbicidally active pyridylsulfonylurea compounds in suspended form, and
b) one or more organic solvents.

2. The oil suspension concentrate as claimed in claim 1 which comprises, as component a), one or more herbicidally active dioxazinepyridylsulfonylurea compounds.

3. The oil suspension concentrate as claimed in claim 1 which comprises, as component b), one or more solvents selected from the group consisting of unsubstituted or substituted hydrocarbons, polar solvents and fatty esters.

4. The oil suspension concentrate as claimed in claim 1 which additionally comprises, comprises c) one or more safeners optionally selected from the group consisting of dichlorophenylpyrazoline-3-carboxylic acid and its esters, 5,5 diphenyl-2-isoxazoline-3-carboxylic acid and its esters and 8-quinolineoxyacetic acid and its esters.

5. The oil suspension concentrate as claimed in claim 4 which additionally comprises d) one or more sulfosuccinates optionally selected from the group consisting of monoesters and diesters of sulfosuccinic acid.

6. The oil suspension concentrate as claimed in claim 5 which additionally comprises.
e) one or more agrochemically active compounds different from a) and c),
f) one or more inorganic salts and/or
g) customary auxiliaries and additives.

7. A process for preparing an oil suspension concentrate as claimed in claim 1 which comprises mixing and optionally grinding components (a) and (b).

8. A method for controlling unwanted plants which comprises applying an oil suspension concentrate as claimed in claim 1 to the plants, a seed or an area on which plants grow.

9-11. (canceled)

12. A herbicidal composition obtainable by diluting an oil suspension concentrate as claimed in claim 1.

13. A process for preparing a herbicidal composition comprising diluting an oil suspension concentrate as claimed in claim 1.

14. A method for controlling unwanted plants which comprises applying a herbicidal composition as claimed in claim 12 to the plants, a seed or an area on which plants grow.

15-16. (canceled)

17. The herbicidal composition of claim 12, wherein the herbicidal composition is a suspension, an emulsion, a suspoemulsion or a solution.

18. The herbicidal composition of claim 12 further comprising one or more sulfosuccinates and/or one or more inorganic salts.

19. A method of stabilizing the herbicidal composition of claim 12 comprising contacting one or more sulfosuccinates and/or one or more inorganic salts with said composition.

20. The oil suspension concentrate of claim 2, wherein the one or more dioxazinepyridylsulfonylureas are selected from compounds having the following formula (I) and/or salts thereof: 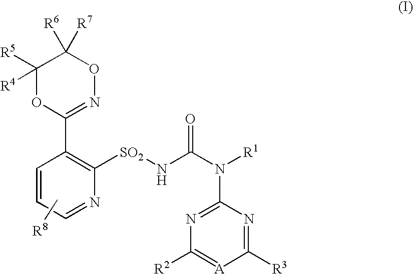
in which
A is nitrogen or a CR¹ grouping, where
R¹¹ is hydrogen, alkyl, halogen or haloalkyl,
R¹ is hydrogen or an optionally substituted radical selected from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴—R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
where in the radicals mentioned above the alkyl and alkylene groups may each contain 1 to 6 carbon atoms, the alkenyl and alkynyl groups may each contain 2 to 6 carbon atoms, the cycloalkyl groups may each contain 3 to 6 carbon atoms and the aryl groups may each contain 6 or 10 carbon atoms.
